(19) United States
(12) Patent Application Publication
(10) Pub. No.: US 2011/0014436 A1
(43) Pub. Date: Jan. 20, 2011

(54) METHODS FOR FORMING HYDROGELS ON SURFACES AND ARTICLES FORMED THEREBY

(75) Inventors: Paul Leon STILES, Chicago, IL (US); Saju Nettikadan, Hawthorn Woods, IL (US); Tung Suet Ruby Lam, Chicago, IL (US); Jae-Won Jang, Glenview, IL (US)

Correspondence Address: FOLEY AND LARDNER LLP;SUITE 500, 3000 K STREET NW, WASHINGTON, DC, 20007, US

(73) Assignee: NanoInk, Inc.

(21) Appl. No.: 12/835,681

(22) Filed: Jul. 13, 2010

Related U.S. Application Data
(60) Provisional application No. 61/225,530, filed on Jul. 14, 2009.
(60) Provisional application No. 61/314,498, filed on Mar. 16, 2010.

(51) Int. Cl. C09D 11/10; C09D 11/14; B05D 5/00; B32B 3/10

(52) U.S. Cl. 428/195.1; 523/400; 524/588; 524/609; 524/560; 524/558; 524/557; 524/565; 524/601; 106/31.13; 524/612; 427/256

(57) ABSTRACT

Methods for forming hydrogels on substrates, including patterned hydrogels. One method comprises providing at least one nanoscopic tip, coating the tip with at least one ink composition, and depositing the ink composition onto at least one substrate, wherein the ink composition comprises at least one hydrogel precursor, the hydrogel precursor adapted to form a hydrogel. The precursor can be converted to the hydrogel after patterning. The ink composition can comprise at least two polymers and can be functionalized. The amount of the polymers and the amount of functionalization can be tuned. Also provided are articles formed from the methods, methods for using the articles, ink compositions and related kits.

### RELATED APPLICATIONS

This application claims priority from U.S. Provisional Application Ser. No. 61/225,530, filed Jul. 14, 2009, and U.S. Provisional Application Ser. No. 61/314,498, filed Mar. 16, 2010, both of which are incorporated herein by reference in their entirety.

### BACKGROUND

Hydrogels are generally understood to be lightly crosslinked networks of water soluble polymers. Hydrogels typically are capable of absorbing, but not dissolving in, water. Hydrogels find use in many applications due, in part, to their unique physical properties, including high porosity and the ability to absorb significant quantities of water. For example, drug molecules can be loaded into the pores of hydrogels and released over time. Other applications for hydrogels include, for example, tissue engineering, regenerative medicine, diagnostics, cellular immobilization, and separation or screening of chemical molecules, biomolecules, or cells. See, e.g., Hoare, T. R. et al., “Hydrogels in Drug Delivery: Progress and challenges, Polymer 49 (2008) 1993-2007 and Kopecek, J., “Hydrogel Biomaterials: A Smart Future?,” Biomaterials 28 (2007), Aug. 13, 2007, pp. 5185-5192.

In many applications simple films of hydrogels have been prepared on substrate surfaces, including via drop or spin casting techniques. Some methods for forming patterned hydrogels on substrates exist. However, these methods typically can suffer from a number of drawbacks. For example, patterning methods using electron beams typically are complex, involving multiple steps and expensive equipment. In addition, electron beam patterning typically is highly destructive to components that may be included in the hydrogel, such as biomolecules. Other patterning methods typically can be limited in their ability to form patterns with small lateral dimensions, including nanoscale dimensions. Finally, many existing patterning methods can provide only simple arrays of hydrogels, in which each of the hydrogel member of the array has the same composition. Therefore, a need exists for methods of forming hydrogels on substrate surfaces that overcome these and other problems.

### SUMMARY

Provided herein are, for example, methods for forming hydrogels from ink compositions on substrates, articles formed from the methods, and methods of using the articles. Also provided are, for example, kits and ink compositions.

One embodiment provides, for example, a method comprising providing at least one nanoscopic tip, coating the tip with at least one ink composition, and depositing the ink composition onto at least one substrate, wherein the ink composition comprises at least one hydrogel precursor, the hydrogel precursor adapted to form a hydrogel.

Another embodiment provides an article comprising: a substrate, and at least one deposit of ink composition on the substrate, wherein the ink composition comprises a hydrogel precursor adapted to form a hydrogel, and further wherein, the deposit has a lateral dimension of 100 μm or less.

Another embodiment provides an article comprising: a substrate, and a plurality of deposits of ink composition on the substrate, wherein the ink composition comprises a hydrogel precursor adapted to form a hydrogel, and further wherein the ink composition of at least one deposit is different from the ink composition of at least another deposit.

Another embodiment provides an ink composition comprising: at least one solvent,

at least one hydrogel precursor, the hydrogel precursor adapted to form a hydrogel, wherein the ink composition is adapted for coating a nanoscopic tip and for depositing the ink composition from the nanoscopic tip to a substrate.

Another embodiment provides a method comprising: depositing a capture molecule from a nanoscopic tip to a substrate, depositing a hydrogel precursor from a nanoscopic tip to the deposited capture molecule, the hydrogel precursor adapted to form a hydrogel.

Another embodiment provides a method comprising: providing at least one stamp, coating the stamp with at least one ink composition, depositing the ink composition onto at least one substrate, wherein the ink composition comprises at least one hydrogel precursor, the hydrogel precursor adapted to form a hydrogel.

Another embodiment provides a method comprising: providing at least one tip optionally disposed on at least one cantilever, disposing on the tip at least one ink composition, optionally, drying the ink composition, depositing the optionally dried ink composition onto at least one substrate, wherein the ink composition comprises at least one hydrogel precursor, converting the hydrogel precursor to form a hydrogel.

Another embodiment provides a method comprising: providing at least one nanoscopic tip, coating the tip with at least one ink composition, depositing the ink composition onto at least one substrate, wherein the ink composition comprises at least one hydrogel precursor, the hydrogel precursor adapted to form a hydrogel and ink comprises at least two different polymers as hydrogel precursor.

Another embodiment provides an article comprising: a substrate, and at least one deposit of ink composition on the substrate, wherein the ink composition comprises a hydrogel precursor adapted to form a hydrogel, and further wherein, the deposit has a lateral dimension of 100 μm or less, wherein the ink composition comprises at least two different polymers.

Another embodiment provides an article comprising: a substrate, and a plurality of deposits of ink composition on the substrate, wherein the ink composition comprises a hydrogel precursor adapted to form a hydrogel, wherein the ink comprises at least two different polymers, and further wherein the ink composition of at least one deposit is different from the ink composition of at least another deposit.

Another embodiment provides an ink composition comprising: at least one solvent, at least one hydrogel precursor, the hydrogel precursor adapted to form a hydrogel, wherein the precursor comprises at least two different polymers, wherein the ink composition is adapted for coating a nanoscopic tip and for depositing the ink composition from the nanoscopic tip to a substrate.

At least one advantage for at least one embodiment is the ability to form hydrogels on substrates, including patterned hydrogels, with a simple, less destructive, less costly process than conventional methods.

At least one further advantage for at least one embodiment is the ability to form a patterned hydrogel on a substrate, wherein the hydrogel includes an encapsulated entity and the patterning and encapsulation occur simultaneously.

At least one further advantage for at least one embodiment is the ability to form patterned hydrogels on a substrate, wherein the pattern includes a nanoscale lateral dimension.

At least one further advantage for at least one embodiment is the ability to form complex patterned hydrogels on a substrate, including patterns in which the composition of one hydrogel deposit in the pattern is different from the composition of another hydrogel deposit.

At least one further advantage for at least one embodiment includes ability to conjugate different molecules, including biomolecules and proteins, on functional hydrogels with selective and specific coupling.

### BRIEF DESCRIPTION OF THE DRAWINGS

FIG. 1 shows a schematic illustration of an article being prepared by an exemplary embodiment of a method for forming hydrogels on a substrate. As shown in the figure (A), a nanoscopic tip is coated with an ink composition including a hydrogel precursor that includes a crosslinkable group and a first functional group. The ink composition is deposited on a substrate (A) and the hydrogel precursor in the ink composition is subsequently converted to a hydrogel (B).

FIG. 2 shows an article prepared by an exemplary embodiment of a method for forming hydrogels on a substrate. In (A), a first array is formed using a first ink composition. In (B), a second array is formed next to the first array, using a second ink composition that is different from the first ink composition. In this case, the first ink composition includes a red dye and the second ink composition includes a yellow dye. Fluorescence images of the article are shown in (C).

FIG. 3 shows an article prepared by an exemplary embodiment of a method for forming hydrogels on a substrate. The article includes a complex pattern of four distinct hydrogels shown with different colors arrayed within a 50 square micron area.

FIG. 4 is an SEM image of an article prepared by an exemplary embodiment of a method for forming hydrogels on a substrate. The figure shows an array of hydrogels (dots) formed from the hydrogel precursor, poly(ethylene glycol) dimethacrylate. Fluorescein molecules are encapsulated in the hydrogels.

FIG. 5A shows a schematic illustration of an article being prepared by an exemplary embodiment of a method for forming hydrogels on a substrate. This figure shows an array of hydrogels formed from poly(ethylene glycol) dimethacrylate with fluorescein-tagged avidin molecules encapsulated in the hydrogels. FIG. 5B shows the fluorescence image of the article formed in FIG. 5A.

FIG. 6 illustrates for one embodiment an effect of temperature on the size of the spots being deposited.

FIG. 7 shows the dimensions of the deposited features in one embodiment.

FIG. 8 shows the results of depositing an ink comprising two different polymers at different ratios in one embodiment.

FIG. 9A-9C illustrate (A) parallel deposition of PEG-DMA derived hydrogels using tip-based nanolithography; (B) creation of functionalized hydrogels from mixed polymer inks; and (C) a schematic showing the ability of the presently described method to create surface gradients on any molecule.

### DETAILED DESCRIPTION

### Introduction

All references cited herein are incorporated by reference in their entirety.

Priority provisional application Ser. No. 61/225,530, filed Jul. 14, 2009, and 61/314,498, filed Mar. 16, 2010, are incorporated herein by reference in their entirety including drawings, working examples, claims, and other embodiments.

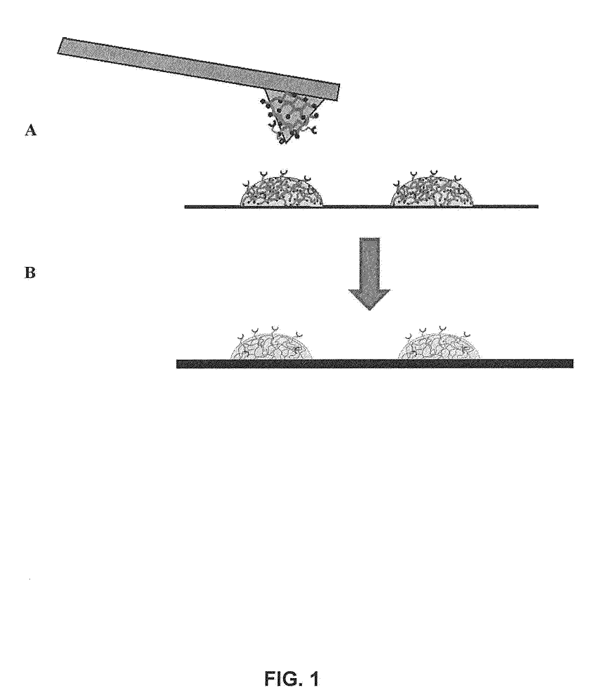

Herein, for some embodiments, methods for forming hydrogels on substrates are provided. One method can include, for example, providing at least one nanoscopic tip, coating the tip with at least one ink composition, and depositing the ink composition onto at least one substrate, wherein the ink composition includes at least one hydrogel precursor. The precursor can be then converted to the hydrogel. See, for example, FIGS. 1 (A and B).

The following references can be used in carrying out deposition of ink compositions with nanoscopic tips. See, for example, Salaita et al., Nature Nanotechnology, 2007, 2 (3), 145-155; Haaheim et al., Proceedings of the Nano Science and Technology Institute, 2007 (May 2007); Haaheim et al., Scanning, 2008, 30 (2), pp. 137-150, Huck, Angewandte Chemie—International Edition, 2007, 46 (16), pp. 2754-2757. See also, for example, U.S. patent Nos. and patent publication nos. U.S. Pat. Nos. 6,635,311; 6,827,979; 2005/019434; 7,060,977; 2003/0185967; 2005/0255237; 7,034,854; 6,642,129; and 2004/0026681. See also, for example, WO 2009/132,321.

In some embodiments described herein, a composition such as an ink composition can consist essentially of components. For example, components can be excluded which materially affect the basic and novel aspects of the inventions.

### Ink Composition and Hydrogel Precursor

An ink composition can be disposed on the tip and optionally dried. And ink composition can be in different forms including, for example, wet, pre-dried, and dried form.

Ink compositions for use with any of the disclosed methods can include at least one hydrogel precursor Ink compositions can also be adapted for coating a nanoscopic tip and for depositing the ink composition from the nanoscopic tip to a substrate. The ink composition including hydrogel precursors for coating onto and depositing from nanoscopic tips onto substrates can be adapted for a particular application. By way of example only, many useful hydrogel precursors are solids at ambient temperatures, but a solution of hydrogel precursor can be preferable for coating a nanoscopic tip. Moreover, when other components are included in the ink composition (as further discussed below), a solution of the hydrogel precursor can be useful for forming a more uniform dispersion of the component in the ink composition. In addition, when the component is a biological material (e.g., biomolecule, cell, or biological organism), it can be preferable to ensure that the solvent used to form the solution dissolves the biological material and the hydrogel precursor without denaturing or otherwise degrading the biological material.

Hydrogel precursors of the disclosed ink compositions can be water soluble polymers that are adapted to form covalent crosslinks with other molecules, including other hydrogel precursors. Hydrogel precursors are known and are either commercially available or can be made by known techniques. Non-limiting examples of hydrogel precursors include poly(ethylene glycol) (PEG), poly(ethylene oxide) (PEO), poly(acrylic acid) (PAA), poly(methyacrylic acid) (PMAA), poly(2-hydroxyethyl methacrylate) (pHEMA), poly(vinyl alcohol) (PVA), poly(N-isopropylacrylamide) (PNIPAAM), poly(lactic acid) (PLA), poly(glycolic acid) (PGA), agarose, chitosan, and combinations thereof, including copolymers thereof. Hydrogel precursors can also include water soluble polymers that are adapted to form physical crosslinks with other molecules, including other hydrogel precursors. These physical crosslinks can be based on physicochemical interactions such as hydrophobic interactions, charge condensation, hydrogen bonding, stereocomplexation, or supramolecular chemistry. Such hydrogel precursors are known and are either commercially available or can be made by known techniques. See, e.g., Hoare, T. R. et al., “Hydrogels in drug delivery: Progress and challenges, Polymer 49 (2008) 1993-2007. Other hydrogel precursors may be found in at least the following references: Winter, J., et al., “Neurotrophin-Eluting Hydrogel Coatings for Neural Stimulating Electrodes,” Journal of Biomedical Materials Research Part B: Applied Biomaterials, Oct. 13, 2006, pp. 551-563.; Krsko, P., et al., “Length-Scale Mediated Adhesion and Directed Growth of Neural Cells by Surface-Patterned Poly(Ethylene Glycol) Hydrogels,” Elsevier: Biomaterials 30 (2009), Nov. 20, 2008, pp 721-729; Campolongo, M. J., et al., “Old Polymer Learns New Tracts,” Nature Materials, Vol. 8, June 2009, pp. 447-448.; Chung, H. J., et al., “Surface Engineered and Drug Releasing Pre-fabricated Scaffolds for Tissue Engineering,” Advanced Drug Delivery Reviews 59 (2007), Apr. 10, 2007, pp. 249-262.; Liedl, T., et al., “Controlled Trapping and Release of Quantum Dots in a DNA-Switchable Hydrogel,” Small 2007, Vol. 3, No. 10, pp. 1688-1693.; Zhang, L., et al., “Biologically Inspired Rosette Nanotubes and Nanocrystalline Hydroxyapatites Hydrogel Nanocomposites as Improved Bone Substitutes,” Nanotechnology 20 (2009), Apr. 3, 2009, 12 pages.; Baird, I., et al., “Mammalian Cell-Seeded Hydrogel Microarrays Printed Via Dip-Pin Technology,” Bio Techniques, Vol. 44, No. 2, February 2008, pp. 249-256; Labean, T., “DNA Bulks Up,” Nature Materials, Vol 5, October 2006, pp. 767-768; Jia, X., et al., “Hybrid Multicomponent Hydrogels for Tissue Engineering,” Macromolecular Bioscience 2009, Vol. 9, 2009, pp. 140-156.; Kopecek, J., “Hydrogel Biomaterials: A Smart Future?,” Biomaterials 28 (2007), Aug. 13, 2007, pp. 5185-5192.; Hoare, T., et al., “Hydrogels in Drug Delivery: Progress and Challenges,” Polymer 49 (2008), Jan. 19, 2008, pp. 1993-2007.; Lin, C., et al., “PEG Hydrogels for the Controlled Release of Biomolecules in Regenerative Medicine,” Pharmaceutical Research, Vol. 26, No. 3, March 2009, pp. 631-643., and U.S. Pat. Pub. Nos. 2007/0286883 and 2006/0014003.

Suitable hydrogel precursors can be liquids or solids at room temperature. In some embodiments, the hydrogel precursor is a solid at room temperature. Such hydrogel precursors can be particularly suitable for use with coating onto, and depositing from, nanoscopic tips, provided that the ink composition is appropriately adapted as discussed above. The molecular weight of the hydrogel precursor can also vary. The molecular weight of the hydrogel precursor can be chosen such that the hydrogel precursor or a solution of the hydrogel precursor flows from the surface of a nanoscopic tip at the optimal rate. For example, hydrogel precursors having too small of a molecular weight can flow from a nanoscopic tip so easily that controlled deposition of the hydrogel precursor is difficult. On the other hand, hydrogel precursors having too large of a molecular weight can resist flowing from a nanoscopic tip to the point that deposition of the hydrogel precursor is precluded. A suitable hydrogel precursor can be a PEG precursor having a molecular weight of about 1000. An example of a hydrogel precursor can be PEG-dimethacrylate. As another example, hydrogel precursors having different molecular weights can be mixed to provide a composition having an overall viscosity that is optimized for coating onto and deposition from a nanoscopic tip.

Any of the hydrogel precursors described above may include crosslinkable groups or other functional groups. For example, a hydrogel precursor can include at least one crosslinkable group. By “crosslinkable group,” it is meant a reactive group that is capable of directly forming a covalent crosslink to another hydrogel precursor or to another polymer, or indirectly forming such a covalent crosslink through, for example, a small molecule crosslinker. A hydrogel precursor can include the crosslinkable group anywhere in the precursor, for example, at a terminal end, as a side group, or within the polymer backbone of precursor. A variety of crosslinkable groups are possible. Non-limiting examples of crosslinkable groups include an aldehyde, an amine, a hydrazide, a (meth)acrylate, or a thiol group. Each of these groups is capable of forming a covalent crosslink by reacting with an appropriate group on another molecule. By way of example only, an acrylate group is capable of reacting with a molecule having a thiol group to form a sulfide crosslink.

A hydrogel precursor can include at least one first functional group adapted to bind a target material. A target material can be a material that is exposed to the hydrogel formed on a substrate according to any of the methods described herein. The binding of the target material to the hydrogel immobilizes the target material to the hydrogel, where it can be detected and further analyzed. Related applications are discussed below. A variety of target materials may be used, including, but not limited to a chemical molecule, biomolecule, cell, or a biological organism such as bacteria or viruses. Biomolecules include, but are not limited to proteins, DNA, RNA, proteins and peptides, antibodies, enzymes, lipids, carbohydrates and the like. Regarding cells, although certain pure hydrogels can be resistant to cell adhesion, cell adhesion proteins and peptides can be added to the ink composition to “program” different cell binding properties. In fact, adding a small amount of certain cell binding proteins or peptides to the ink composition can change the hydrogel formed from the hydrogel precursor from one that repels cell adhesion to one that actually initiates cell adhesion. The addition of certain entities, such as cell adhesion proteins or peptides, to the ink composition is further discussed below.

A variety of first functional groups may be used, including, but not limited to an amine, a carboxyl, a thiol, a maleimide, an epoxide, a (meth)acrylate, or a hydroxyl group. Each of these groups is capable of forming a bond with an appropriate group on a target material. By way of example only, a thiol group is capable of reacting with a target material having a maleimide group to form a thioether bond. As another example, an amine group is capable of reacting with a target material having a succinimidyl ester group to form a carboxamide.

A hydrogel precursor can also include at least one second functional group adapted to bind to the surface of the substrate, upon which the hydrogel precursor is deposited. If the surface of the substrate has been modified as further described below, the second functional group can also be adapted to bind to the surface of the modified substrate. Binding of the hydrogel precursor to the substrate can help retain the hydrogel formed from the precursor on the substrate during use, especially repeat uses. This second functional group can be the same as, or different from, the first functional group described above. A variety of second functional groups are possible, depending upon the composition of the modified or unmodified substrate. By way of example only, the second functional group can be a thiol group or a silane group. Thiol groups can react with gold substrates. Silane groups can react with silicon oxide or glass substrates to form Si—O—Si bonds.

Any of the functional groups above may be included anywhere in the hydrogel precursors as described above for crosslinkable groups. Hydrogel precursors having any of the functional groups described above are known and are commercially available or can be made through known techniques. One example of a suitable hydrogel precursor having a first functional group is poly(ethylene glycol) dimethacrylate.

The number of crosslinkable groups and, if present, other functional groups in the hydrogel precursor, may vary. The number of crosslinkable groups can be varied depending upon the desired crosslinking density of the hydrogel formed from the hydrogel precursor. Different crosslinking densities can provide hydrogels with different properties, such as different pore sizes, and different water contents. For example, hydrogels with greater crosslinking are denser and become less soluble in water. Similarly, the number of functional groups in the hydrogel precursor is not particularly limited. Hydrogel in one embodiment can be a crosslinked polymer that is biocompatible and with properties that resemble biological soft tissue. Hydrogel can resist protein and cell binding. On the other hand, protein and cell binding functionality can be added into the hydrogel matrix via functionalization.

Ink compositions can also include a variety of other components. For example, the ink composition can include a solvent. A variety of solvents may be used, including water or organic solvents such as ethanol, methanol, isopropyl alcohol, or acetonitrile. The solvent can be chosen to be compatible with an entity adapted to be encapsulated in the hydrogel formed from the hydrogel precursor. By way of example only, when the entity is a protein, a solvent that does not denature the protein can be used. The solvent also can be chosen such that it adheres well to the nanoscopic tips used to deliver the disclosed ink compositions.

The ink composition can also include a crosslinking agent. By “crosslinking agent” it is meant a molecule that facilitates crosslinking in the hydrogel precursor used to form the hydrogel. By way of example only, a crosslinking agent can include a small molecule crosslinker, for example, a small molecule that reacts with two or more hydrogel precursors to form a crosslink between them. As another example, in the case of charged hydrogel precursors capable of forming physical crosslinks through charge coupling, a crosslinking agent can be a polymer or other molecule having a overall charge opposite to the hydrogel precursor. The oppositely charged polymer or molecule “links” the hydrogel precursors together through charge coupling. Crosslinking agents also include free-radical initiators. Free-radical initiators provide a source of free radicals which can propagate through multiple carbon-carbon double bonds on hydrogel precursors, thus crosslinking the precursors. This type of crosslinking is known as free-radical polymerization. A variety of free-radical initiators may be used, including those that generate free radicals by heat, a redox reaction, or light. Free-radical initiators that generate free radicals by light are also known as photoinitiators. Free-radical initiators, including photoinitiators, are known and are commercially available. Non-limiting examples of photoinitiators include 2-ethoxy-3-methoxy-1-phenylpropan-1-one and 2,2-dimethyl-2-phenylacetophenone.

The ink composition can also include at least one entity adapted to be encapsulated in the hydrogel formed from the hydrogel precursor. As described above, a hydrogel is a crosslinked network of water-soluble polymers. The porosity of the hydrogel and the ability of the hydrogel to absorb water allows a variety of entities to be encapsulated in the polymeric network. In addition, the aqueous environment provided within the hydrogel network provides a biocompatible medium for biological entities. Encapsulation can, but need not, include binding of the entity to the hydrogel formed from the hydrogel precursor. In some embodiments, the entity is not bound to the hydrogel formed from the hydrogel precursor. Suitable entities for the disclosed ink compositions include, but are not limited to biomolecules, cells, biological organisms, or other molecules, including polymers. Any of the biomolecules and biological organisms described above may be used. The encapsulation of these entities within the hydrogel localizes the entity so it can be detected and/or further analyzed. Encapsulated entities can also be used as a means to “capture” any of the target materials described above. Related applications are described below.

Any of the entities may include any of the functional groups described above which are adapted to bind to a target material and/or to the surface of a substrate. By way of example only, the entity can be a biomolecule having a third functional group adapted to bind to the surface of a substrate. The third functional group further immobilizes the biomolecule to the substrate, while the hydrogel provides a biocompatible environment as described above. A variety of third functional groups may be used, including any of those described above for the second functional group. As another example, the entity can be a polymer having a fourth functional group adapted to bind to a target material. Because the polymer simply provides a scaffold for capturing the target material, the type of polymer is not particularly limited. A variety of fourth functional groups may be used, including any of those described above for the first functional group. The number of functional groups included on the entities may vary. These functional groups may be naturally present on the entity or known techniques can be used to include such groups on the entity.

The ink composition can also include additives adapted to facilitate the dissolution and dispersing of an entity to be encapsulated in the hydrogel. By way of example only, when the entity is a biological material, the additive can include glycerol, dimethyl formamide, or dimethyl sulfoxide.

The concentration of the various components of the ink composition may vary. For example, the concentration of the hydrogel precursor may vary from about 1 mg/mL to about 100 mg/mL. This includes embodiments where the concentration is about 10, 30, 50, 70, and 90 mg/mL. However, other concentrations are possible. High concentrations of hydrogel precursor tend to form hydrogels more readily than low concentrations of hydrogel precursor. The concentration of hydrogel precursor can also be chosen depending upon the concentration of an entity to be encapsulated in the hydrogel and the degree of desired encapsulation. When a free-radical photoinitiator is used to crosslink the hydrogel precursor, the amount of the photoinitiator can vary from about 1% to about 3% of the total volume of the ink composition. However, other amounts are possible. The examples below provide some exemplary concentrations for some exemplary ink compositions.

### Substrates

The substrates used in the disclosed methods may vary. Substrates may be made of any material which can be modified by the disclosed ink compositions. The substrate can be a solid surface; it can be a flat surface. Useful substrates include metals (e.g., gold, silver, aluminum, copper, platinum, and palladium), silica, various glasses, mica, or kapton. However, other substrates are possible, including metal oxides, semiconductor materials, magnetic materials, polymers, polymer coated substrates, and superconductor materials. Such substrates are commercially available or can be made using known techniques. The substrates can be of any shape and size, including flat and curved substrates. As further described below, the surfaces of the substrates can be unmodified or modified. For example, substrates can be modified so the ink composition wets the surface less and has a higher height.

### Nanoscopic Tips

As noted above, one method can involve the use of nanoscopic tips to deliver the ink composition to the substrate. Nanoscopic tips can include tips used in atomic scale imaging, including atomic force microscope (AFM) tips, near field scanning optical microscope (NSOM) tips, scanning tunneling microscope (STM) tips, and tips used in Dip-Pen Nanolithography® (DPN®). Tips can be solid or hollow and can have a tip radius of, for example, less than 250 nm, or less than 100 nm, or less than 50 nm, or less than 25 nm. Tips can be formed at the end of a cantilever structure. Tips, with or without the cantilever structure, can be mounted to a holder. The tips may be provided as single tips, a plurality of tips, or an array of tips, including one-dimensional arrays, two-dimensional arrays, and high density arrays. Tips may be uncoated or coated, for example, with a layer of material that facilitates the adsorption of the ink composition to the tip. Such tips are known and are commercially available or can be made by known methods. See, e.g., Scanning Probe Microscopes Beyond Imaging, Ed. P. Samori, 2006; U.S. Pat. Nos. 6,635,311 and 6,827,979 to Mirkin et al; and U.S. Pat. Pub. No. 20080105042 to Mirkin et al.

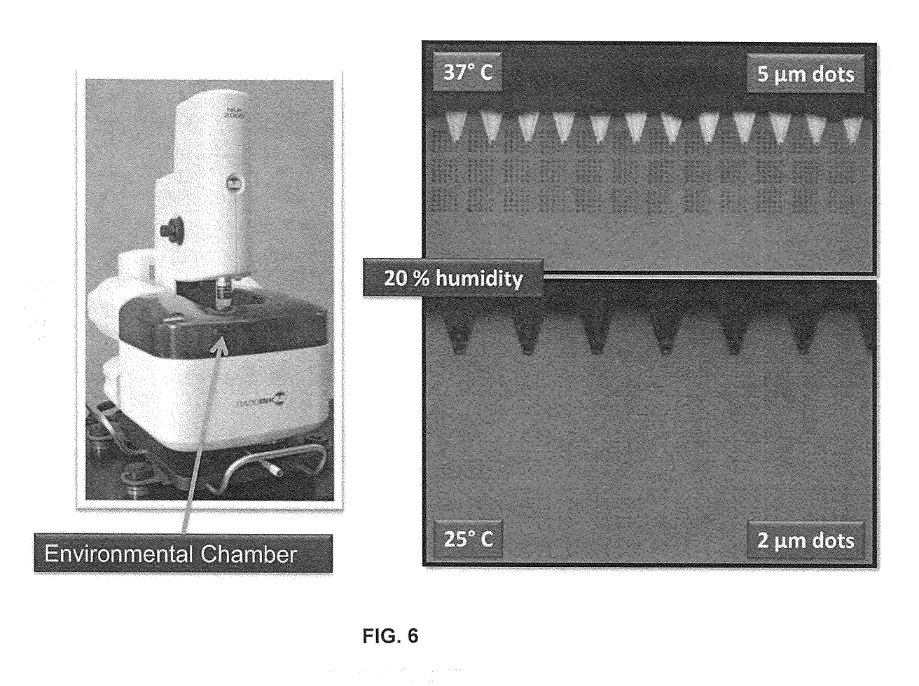

Any of the nanoscopic tips described above can be provided as part of a scanning probe microscope system. Tip deposition and scanning probe microscope systems include, but are not limited to the DPN 5000, NLP 2000, and the NSCRIPTOR™ systems commercially available from NanoInk, Inc. Skokie, Ill. The NLP 2000 is shown in FIGS. 6A and 6B. Other systems include scanning tunneling microscopes, atomic force microscopes, and near-field optical scanning microscopes, which are also commercially available.

Patterning devices, including tips and cantilevers and associated methods, are described in, for example, U.S. provisional application 61/324,167 filed Apr. 14, 2010. See also WO 2009/132,321 “Polymer Pen Lithography”. Tips can comprise one or more polymeric materials, including soft polymeric materials, including one or more elastomers, siloxanes, silicones, and the like.

The tips in some embodiments are disposed on a cantilever, whereas tips in other embodiments are disposed on a supporting substrate or chip, but without a cantilever.

### Coating Step

As noted above, one method can involve coating any of the nanoscopic tips described above with any of the disclosed ink compositions. A variety of techniques may be used to coat the nanoscopic tips. By way of example only, the coating step can include dipping the tip into the ink composition. The tip can be maintained in contact with the ink composition for a time sufficient for the tip to be coated. These times may vary, for example, from about 30 seconds to about 3 minutes. The tip can be dipped into the ink composition a single time or multiple times. The tip can be dried after dipping. This and other coating methods are known. See, e.g., U.S. Pat. No. 6,827,979 to Mirkin et al. As another example, the coating step can include providing an inkwell loaded with the ink composition. The inkwell can include one or more cavities having a geometry that matches the geometry of the tips. Various volumes of ink composition can be provided in the cavities of the inkwells. Tips can be dipped into the inkwell in order to be coated with the ink composition. Dipping times and techniques can vary as described above Inkwells and methods of making and using the inkwells are known. See, e.g., U.S. Pat. No. 7,034,854 to Cruchon-Dupeyrat et al.

### Deposition Step

As noted above, one method can involve depositing the ink composition from the coated nanoscopic tip onto at least one substrate. The depositing step can include positioning the tip in proximity to the substrate for a period of time. “Proximity” can include actual contact of the tip to the substrate surface. However, the tip need not actually contact the substrate surface. When the tip is sufficiently close to the substrate surface, the ink composition can form a meniscus which bridges the gap between the tip and the substrate surface, thereby allowing the ink composition to be deposited onto the surface. Therefore, “proximity” includes those distances over which such a meniscus can form. See, e.g., U.S. Pat. No. 6,827,979 to Mirkin et al. The period of time (also known as the “dwell time”) that the tip is in proximity to the substrate may vary. The dwell time can affect the lateral size of the deposited ink composition on the substrate, with longer dwell times providing larger deposits and smaller dwell times providing smaller deposits. Suitable dwell times, include, but are not limited to 0.1, 0.2, 0.5, 1, 2, 6, 8, 10 seconds or even more. Shorter or longer dwell times are also possible.

The depositing step can also include carrying out the deposition at a particular humidity level. The humidity level is not particularly limited, but can be chosen to be a level that is sufficient to hydrate the hydrogel formed from the hydrogel precursor. The humidity level can range from about 10% to about 100%. This includes embodiments in which the humidity level is about 20, 40, 60, or 80%. However, other humidity levels are possible. Because hydrogels “swell” upon absorption of water, the humidity level used during the deposition step can affect the lateral size of the hydrogel formed on the substrate, with greater humidity levels providing larger hydrogels and smaller humidity levels providing smaller hydrogels. Environmental chambers can be included on any of the scanning probe microscope systems described above to control the humidity level.

The depositing step can provide a single deposit of ink composition on a substrate or a plurality of deposits. Multiplexing, and parallel deposition of different inks can be employed. A plurality of deposits may be achieved by moving the tip to a different location on the substrate (or by moving the substrate to a different position underneath the tip). These motions may be achieved by using of any of the scanning probe microscope systems described above. The depositing step can also provide a pattern on the surface of the substrate, the pattern including isolated regions of deposited ink composition. By “isolated” it is meant that at least one region of deposited ink composition is separated from another region of deposited ink composition by a region free from deposited ink composition. The pattern may be regular, for example, an array, or irregular. The pattern can include regions of deposited ink composition having various sizes and shapes. By way of example only, a lateral dimension of a region of deposited ink composition can be 100 μm, 50 μm, 10 μm , 5 μm, 1000 nm, 800 nm, 500 nm, 200 nm, 100 nm or less. However, larger and smaller lateral dimensions are possible. Similarly, the height of the region of deposited ink composition may vary. By way of example only, a height of a region can be 500 nm, 250 nm, 100 nm, 50 nm, 10 nm or less. However, larger and smaller heights are possible. Possible shapes of the regions of deposited ink composition include, but are not limited to a dot, a line, a cross, a geometric shape, or combinations thereof.

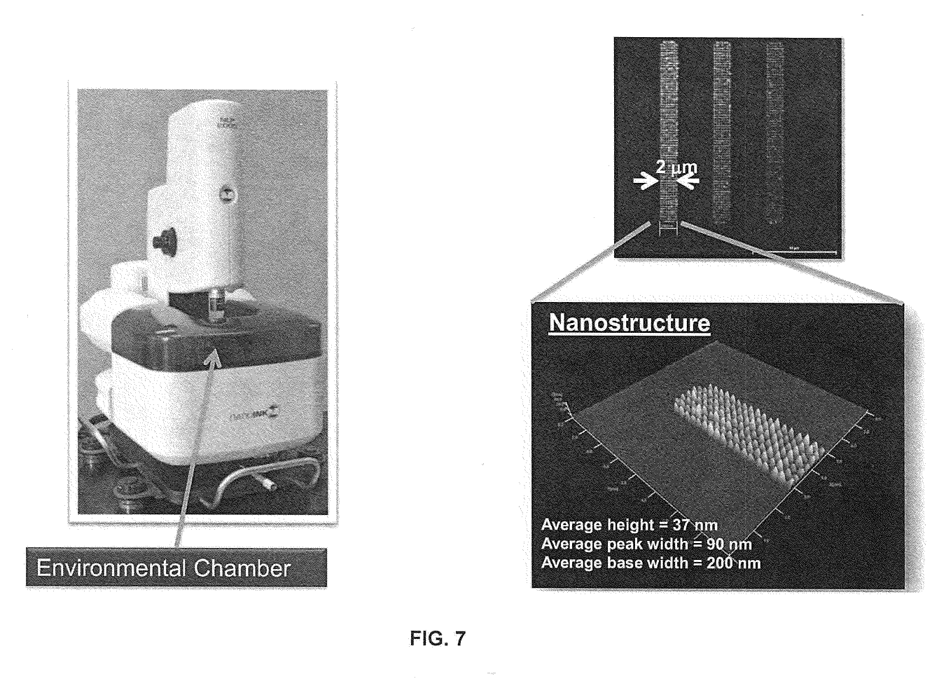

In one embodiment, the nanostructure has an average height of about 37 nm, an average peak width of about 90 nm, and an average base width of about 200 nm. See FIG. 7.

The depositing step can provide a plurality of regions of deposited ink composition on a substrate, wherein the ink composition of at least one region is the same or different from the ink composition of another region. For example, all regions could have the same ink composition or all regions could have a different ink composition. In addition, one set of regions could have the same ink composition as other regions in the set, but a different ink composition from another set of regions. By “different ink composition” it is meant that the components of the ink composition of the region differ from the components of the ink composition of another region. By way of example only, a first region of deposited ink composition may differ from a second region because the hydrogel precursor included in the ink composition of the first region is different from the hydrogel precursor included in the ink composition of the second region. As another example, a first region of deposited ink composition may differ from a second region because the entity adapted to be encapsulated in the hydrogel formed from the hydrogel precursor used in the ink composition of the first region is different from the entity in the ink composition of the second region. As further discussed below, such depositing steps can provide arrays of deposited ink composition that can be use to screen for the presence of multiple, different target biomolecules in a single step.

Not only can the depositing step provide a plurality of regions wherein the regions have different ink compositions, but also, the depositing step can provide a plurality of regions wherein the regions have different sizes. Because the tip contact time and/or the humidity level can be changed during the deposition process, it is possible to achieve complex patterns of deposited ink composition (and hydrogels formed from the deposited ink compositions) wherein the regions of deposited ink composition have different sizes.

### Other Steps

The methods described above can include a number of other steps. For example, the methods can further include converting the hydrogel precursor to the hydrogel. The converting step can be carried out after the ink composition has been deposited on the substrate. Various techniques may be used to accomplish the conversion, including providing an environmental trigger to facilitate the crosslinking of the hydrogel precursors. As discussed above, the environmental trigger may vary depending upon the type of crosslinking Possible environmental triggers include, but are not limited to a change in temperature, a change in pH, or exposure to light. By way of example only, when the ink composition includes a free-radical photoinitiator, the converting step can include exposing the hydrogel precursor to light. The wavelength of light may vary depending upon the type of free-radical photoinitiator. The light can be UV light. The length of exposure to the light may vary, depending upon such considerations as ensuring that a sufficient amount of crosslinking has occurred and minimizing damage to any components of the ink composition that may be sensitive to the light, including biomolecules, cells, and biological organisms. The length of exposure can be 1, 2, 3, 4, 5, or more minutes. However, shorter and longer times are possible. Nitrogen gas or a similar gas can be provided during the conversion process to increase the efficiency of the crosslinking of the hydrogel precursor. Finally, in some embodiments, the converting step does not include exposing the hydrogel precursor to an electron beam.

The methods can further include hydrating the ink composition or hydrating the hydrogel once it has been formed from the hydrogel precursor in the ink composition. As described above with respect to the deposition step, hydrating the ink composition may be accomplished by carrying out the deposition step under humidity. The water present in the ink composition can serve to hydrate the hydrogel once it has been formed from the hydrogel precursor. Alternatively, or in addition, the formed hydrogel can be exposed to various amounts of water for various times in order to provide the hydrogel with any of the water contents discussed above.

The methods can further include modifying the substrate so that the ink composition deposited thereon forms an increased height upon deposition as compared to an unmodified substrate. The inventors have discovered that certain ink compositions deposited on unmodified, hydrophilic substrates resulted in relatively large, flat “pools” of ink composition on the substrate. However, by modifying the substrate to render the substrate more hydrophobic, regions of deposited ink composition having smaller lateral dimensions, but greater heights are possible. The modification step can include functionalizing the substrate by exposing the substrate to various molecular compounds adapted to alter the hydrophilicity of the substrate.

The methods described above are further illustrated by the following figures. FIG. 1A shows a schematic of a nanoscopic tip coated with an ink composition. The ink composition can include a hydrogel precursor (represented by the wavy lines) having a crosslinkable group (represented by the black dots) and a first functional group (represented by the half circles). The nanoscopic tip can deposit nanoscale amounts of the ink composition. As shown in FIG. 1B, after deposition, the hydrogel precursor in the ink composition can be converted to the hydrogel by inducing crosslinking of the hydrogel precursor via the crosslinkable groups. The conversion can be accomplished using any of the techniques described above, including by UV light, a change in pH, or a change in temperature. As described above, the ink composition can include various entities, including biomolecules, to be encapsulated into the hydrogel formed from the hydrogel precursor in the ink composition. By contrast to methods involving an electron beam (which can destroy biomolecules included in the ink composition), the disclosed methods are capable of maintaining the activity of biomolecules included in the ink composition.

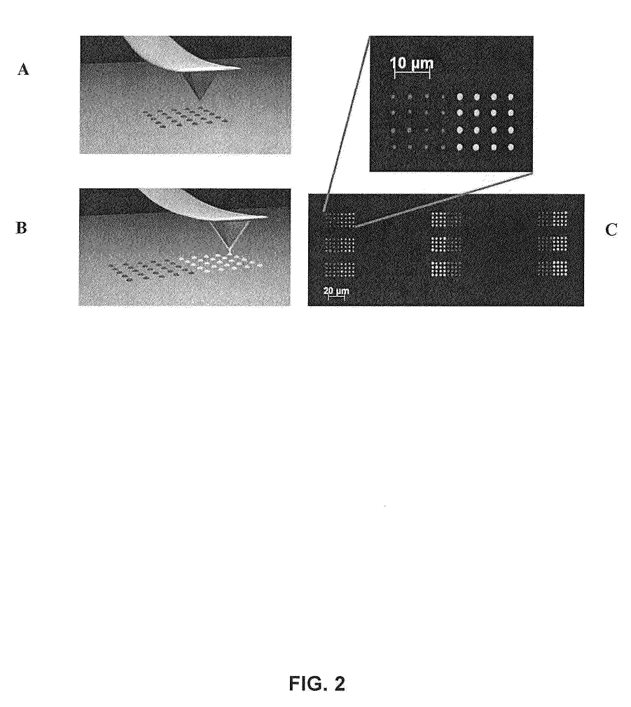

FIG. 2A shows a schematic of a nanoscopic tip coated with a first ink composition that is used to form a first array of hydrogels on a substrate. As shown in FIG. 2B, the nanoscopic tip can then be coated with a second ink composition and used to form a second array of hydrogels on the substrate next to the first array. The composition of the hydrogels in the first array can be different from the second array. In this case, the first array includes a red dye and the second array includes a yellow dye, but the composition of the inks in the first array and the second array can differ in any of the ways described above. FIG. 2C shows the fluorescence image of the arrays. These arrays can be formed in situ, without ever having to remove the substrate. Moreover, alignment of the arrays is simpler than with certain stamping techniques.

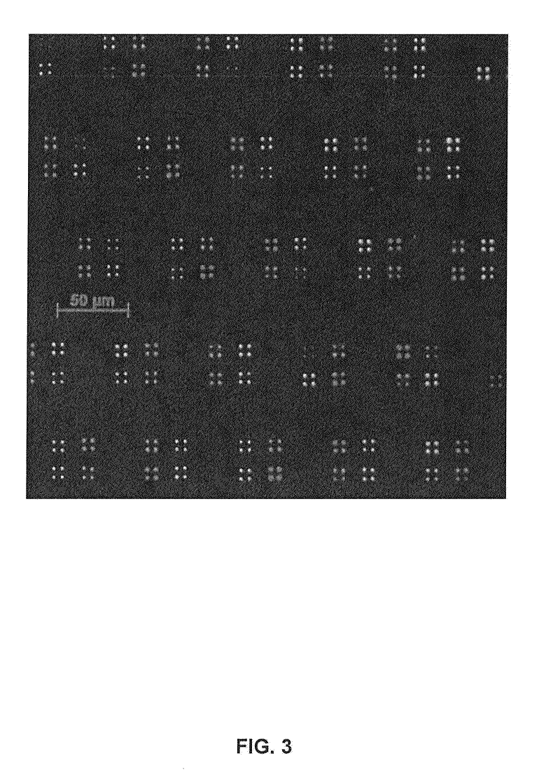

FIG. 3 shows an even more complex pattern of hydrogels formed on a substrate. In this figure, the disclosed methods were used to deposit four different ink compositions in a pattern onto a substrate (a first ink composition includes a red dye, a second ink composition includes a blue dye, a third ink composition includes a green dye, and a fourth ink composition includes a yellow dye). After deposition, the hydrogel precursor in the ink compositions were converted to the hydrogel.

Other Methods

Another method can include depositing a capture molecule from a nanoscopic tip to a substrate and depositing a hydrogel precursor from a nanoscopic tip to the deposited capture molecule. Any of the nanoscopic tips, substrates, and hydrogel precursors described above can be used. Hydrogel precursors can be provided in any of the ink compositions described above. In addition, any of the techniques described above for the coating steps and deposition steps can be applied to this method. This method may also include any of the “other steps” described above.

Yet another method can include providing at least one stamp, coating the stamp with at least one ink composition having at least one hydrogel precursor, and depositing the ink composition onto at least one substrate. Any of the ink compositions, hydrogel precursors, and substrates described above can be used. In addition, any of the techniques described above for the coating steps and deposition steps can be applied to this method. This method may also include any of the “other steps” described above. A variety of stamps may be used, including, but not limited to polymeric stamps, such as those used in microcontact printing. The stamp may be an elastomeric tip array such as those described in Hong et al., “A micromachined elastomeric tip array for contact printing with variable dot size and density,” J. Micromech. Microeng. 18 (2008).

### Articles

Articles formed using any of the methods described above are also provided. Thus, in a basic embodiment, an article can include a substrate and at least one deposit of ink composition on the substrate. After the hydrogel precursor in the ink composition has been converted to the hydrogel, an article can include a substrate and at least one deposit of hydrogel on the substrate. Numerous embodiments of the articles are possible, depending, in part, upon the nature of the deposition step used in the method and the components of the ink composition. A few, exemplary embodiments are discussed below, although these examples are not intended to be limiting in any way.

One article can include a substrate and at least one deposit of ink composition on the substrate, wherein the ink composition includes a hydrogel precursor adapted to form a hydrogel and the deposit has a lateral dimension of 100 μm or less. Other lateral dimensions are possible, including those described above. The hydrogel precursor in the ink composition can be, but need not be, crosslinked. Any of the ink compositions described above can be used to form the article. By way of example only, the ink composition used to form the article can include at least one entity adapted to be encapsulated in the hydrogel formed from the hydrogel precursor. Any of the entities described above can be used, including polymers and biomolecules. As noted above, the entity can be encapsulated in, but not bound to, the hydrogel formed from the hydrogel precursor. The article can further include a plurality of deposits of ink composition. The plurality of deposits can be arranged in regular or irregular patterns as described above. The plurality of deposits can include deposits separated by regions on the substrate substantially free from ink composition. For those articles having a plurality of deposits, the ink composition of the deposits can be the same, or different from one another.

Another article can include a substrate and a plurality of deposits of ink composition on the substrate, wherein the ink composition includes a hydrogel precursor adapted to form a hydrogel and the ink composition of at least one deposit is different from the ink composition of at least another deposit. In some cases, the hydrogel precursor in the ink composition of at least one deposit can be different from the hydrogel precursor in the ink composition of at least another deposit. Any of the ink compositions described above can be used to form the article. By way of example only, the ink composition used to form the article can include at least one entity adapted to be encapsulated in the hydrogel formed from the hydrogel precursor. Any of the entities described above can be used, including polymers and biomolecules. In some cases, the entity in the ink composition of at least one deposit can be different from the entity in the ink composition of at least another deposit.

### Ink Compositions

Ink compositions for use with any of the methods described herein are also provided. Ink compositions are described above Ink compositions can comprise solvent or be solvent free as long as they are liquid, and are able to be disposed onto a tip for coating and deposition. Aqueous ink compositions comprising biomolecules such as proteins are particularly of interest.

### Applications

Also disclosed are applications for any of the articles described above. Many such applications exist for articles having hydrogels deposited on substrate surfaces, especially articles having patterned hydrogels. By way of example only, articles having patterned hydrogels thereon can be used for biological and chemical screenings to identify and/or quantify a biological or chemical target material (e.g., immunoassays, enzyme activity assays, genomics, and proteomics). These screenings can be useful in identifying, designing, or refining drug candidates, enzyme inhibitors, ligands for receptors, and receptors for ligands, and in genomics and proteomics. One possible screening method could include providing any of the disclosed hydrogel-containing articles, exposing the article to any of the disclosed target materials, and detecting the target material. As another example, articles having patterned hydrogels thereon can be used as a platform for immobilizing (i.e., through encapsulation) and studying a variety of entities, including biomolecules, cells, and biological organisms. Such platforms can be useful for examining the effects of chemical and biological target materials on the immobilized biomolecules, cells, and biological organisms, particularly for drug development and toxicological applications. One possible related method can include providing any of the disclosed hydrogel-containing articles, wherein the hydrogel includes an encapsulated biomolecule, cell, or biological organism, and exposing the article to any of the disclosed target materials (make sure small molecules encompassed). As yet another example, articles having patterned hydrogels thereon can be used as a platform for adhering, growing, and promoting differentiation of cells. Such platforms are useful for tissue engineering and regenerative medical applications. One possible related method could include providing any of the disclosed hydrogel-containing articles, adhering a cell to the article, and allowing the cell to grow or differentiate. For other applications, see, e.g., any of the references disclosed above. Also see Macromol. Biosci. 2009, 9, 140-156; Nature Materials, Vol. 3, 58-64, 2004; Advanced Drug Delivery Reviews 59 (2007) 249-262; and Nature Materials, Vol. 8, 432-437 (2009).

### Kits

One or more of the components described herein can be combined into useful kits. The kits can further comprise one or more instructions on how to use the kit, including use with any of the methods described herein. Ink compositions can be provided.

### ADDITIONAL EMBODIMENTS

These embodiments relate generally to nanoscale and/or microscale patterning of functionalized polymer gels using tip based nanolithography.

In some embodiments of tip based lithography, an ink composition comprising mixture of two or more polymers can be delivered to a surface. The first polymer can be a linear polymer and the second polymer, different from the first, can comprise at least two, or at least three, or at least four arms. In some embodiments, one linear polymer (polymer 1) has an acrylate or methacrylate (or any other chain polymerization) functional group on both ends. In some embodiments, the other polymer (polymer 2) can be a multi-arm polymer, e.g., a 4-arm polymer (same or different backbone as polymer 1) with a different functionality that reacts with the functional groups on polymer 1.

Temperature and/or humidity can be used to control the size of the deposited spot. In one embodiment, a lower temperature can be used to reduce spot size. The substrate temperature can be controlled and lowered. The effect of the temperature on the spot size can be seen on FIG. 6. Also, gradients can be generated wherein mixtures of polymers are used in controlled amounts to generate ratios, including weight ratios, from, for example, 1:20 to 20:1, or 1:10 to 10:1, or 1:4 to 4:1.

One can create arbitrary patterns of protein functionalized hydrogels. Also, one can generate protein gradients of arbitrary size and shape. Also, one can write these patterns on many substrates.

After the two are mixed and delivered to the surface, in some embodiments, the two polymers can be crosslinked together. Polymer 1 follows a chain growth mechanism with itself, in some embodiments, while polymer 1 and 2 follow a step growth mechanism. The result in some embodiments is that all or substantially all of the functional groups on polymer 1 are consumed, while a fraction of the functional groups on polymer 2 remain unreacted, leaving them available for use in a subsequent reaction. In some embodiments, the number of unreacted functional groups on the resulting gel can be dependent on the ratio of polymer 1 to polymer 2 in the original ink. This provides, in some embodiments, a simple way to tune the surface coverage on the gel. One of the primary differentiators of this method over previous ones, in some embodiments, is that no solvents or carriers are used to transport the polymers from the tip to the surface.

In one embodiment, the present method provides a general method of binding a biomolecule to the hydrogel pattern. By controlling the functionality of the hydrogel, one can control the number of proteins on each hydrogel. The pattern feature sizes can be less than 5 microns, such as less than 1 micron, such as less than 500 nm, such as less than or equal to 100 nm. The generality of the present method can allow patterning the feature onto any surface.

The present method also allow rapid formation of complex multicomponent extracellular matrix (ECM) protein and morphogen patterns. This can be particularly beneficial to investigate cell mobility, cell-cell interactions, drug delivery, cell sorting, cell assay development, cell adhesion, directed neurite growth, stem cell differentiation, morphogenesis, and evolutionary and developmental biology.

In some embodiments, polymers 1 and 2 are mixed together (polymerization initiator may or may not be needed) to form a viscous liquid. In some embodiments, the liquid is delivered to the tip arrays and are then patterned to a substrate. In some embodiments, after the desired pattern is formed, the polymer pattern is crosslinked together. In some embodiments, at the end of the polymerization the polymerization mechanism consumes all of polymer 1, while polymer 2 still contains unreacted functional groups that can be used in a subsequent reaction. In some embodiments, the number of unreacted functional groups on the resulting gel is dependent on the ratio of polymer 1 to polymer 2 in the original ink. In some embodiments, this provides a simple venue to tune the surface coverage on the gel.

Functionalized polymer gels (hydrogels) can be patterned by existing photolithography technique, but often the pattern can only have a single functionality. The presently described method can allow delivery of multiple functional polymers in a single step in some embodiments. The method can also allow positioning of the gels in arbitrary locations with micro and nanoscale registry in some embodiments. Creating high-resolution features remains a challenge, as evidenced in that most of those created by existing methods are limited to 10's and 100's of microns. Additionally, existing technology generally needs for each new pattern to have a new mask or master. Existing stamping technology also faces same or substantially the same problems that were described with photolithography.

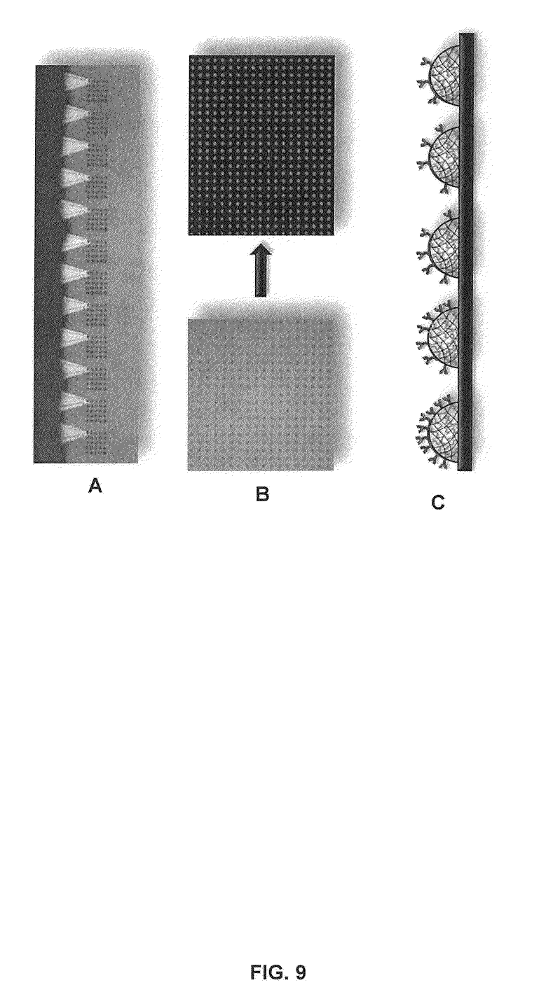

In the present embodiments, the functional groups can be different, thereby providing the ability to simultaneously deposit multiple polymer gels with multiple functionalities. This multiplexed deposition is not usually possible with existing methods. In one embodiment, parallel deposition of PEG-DMA derived hydrogels using a tip-based nanolithography is shown in FIG. 9A

### WORKING EXAMPLES

Additional embodiments are provided by the following non-limiting working examples.

### Example 1

### Formation of a Patterned Hydrogel Including an Encapsulated Small Molecule

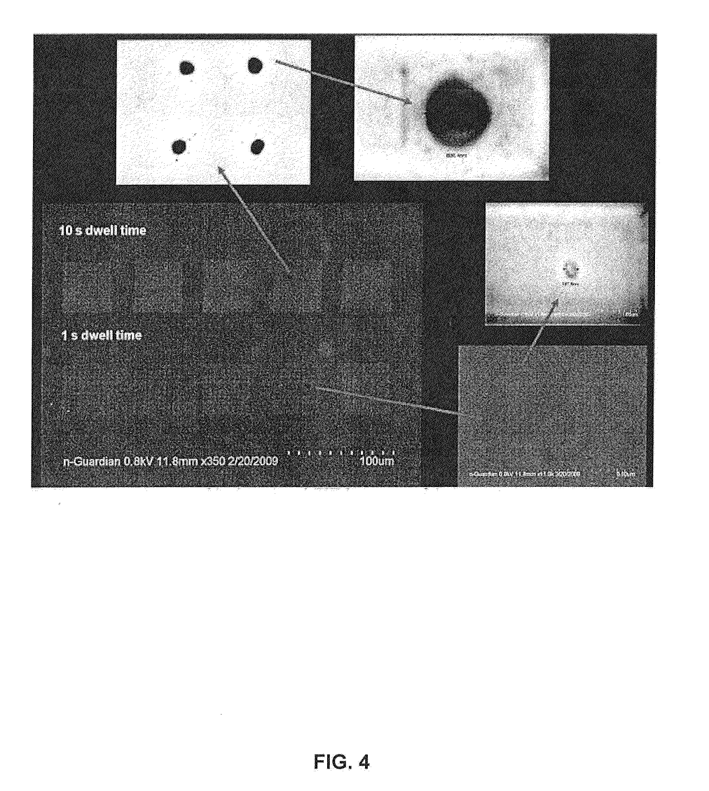

An ink composition including poly(ethylene glycol) dimethacrylate (PEG-DMA, Polysciences, Inc.), fluorescein (Sigma-Aldrich, Inc.), and the free-radical photoinitiator, 2-ethoxy-3-methoxy-1-phenylpropan-1-one (Sigma-Aldrich, Inc.), was prepared. 1000 molecular weight PEG-DMA was dissolved in acetonitrile (5 mg/mL), and fluorescein ethanolic solution (10 μL/mL) was prepared. Both solutions were mixed in 1:1 volume ratio (1 mL:1 mL), and 20 μl of photoinitiator was added in the ink solution. The tips of a one-dimensional array of nanoscopic tips (M-type probe, NanoInk, Inc.) were coated with the ink composition by dipping for 30 seconds, and the inked tip array was left for 5 min to let the ink dry. The ink composition was deposited from the tips onto a gold substrate using various dwell times (1 s and 10 s) in 50% of humidity condition. 10×10 dots arrays with different dwell times were printed on a gold substrate with 100 μm of distance in y-direction. Next, the ink composition was exposed to UV light in order to convert the hydrogel precursor into a hydrogel. Photo-polymerization to hydrogel was carried out by exposing UV light (10 mW/cm², 365 nm) for 8 min with inert nitrogen gas atmosphere. The patterned hydrogel was examined using fluorescence microscopy and scanning electron microscopy. The fluorescence images showed an array of distinct fluorescent spots before and after hydrogel formation, confirming the encapsulation of the fluorescein molecules. SEM images are shown in FIG. 4. As shown in this figure, longer dwell times increase the lateral dimension of the hydrogel. In particular the diameter of a spot in the array patterned with a 10 s dwell time was less than 1 μm (about 850 nm) while the diameter of a spot in the array patterned with a 1 s dwell time was less than 200 nm (about 170 nm).

### Example 2

### Formation of a Patterned Hydrogel Including an Encapsulated Protein

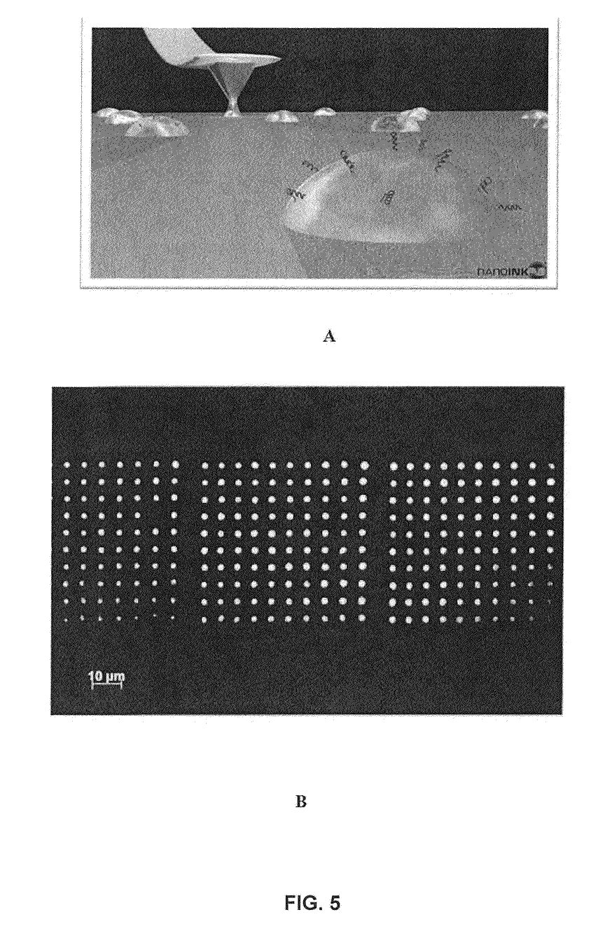

An ink composition including poly(ethylene glycol) dimethacrylate (PEG-DMA, Polysciences, Inc.), fluorescein tagged avidin (Sigma-Aldrich, Inc.), glycerol (Sigma-Aldrich, Inc.), and the free-radical photoinitiator, 2-ethoxy-3-methoxy-1-phenylpropan-1-one (Sigma-Aldrich, Inc.), was prepared. Aqueous PEG-DMA solution (molecular weight: 1000, 5 mg/mL) and glycerol mixed (4:1 of volume ratio) ink solution was prepared, and fluorescein tagged avidin in phosphate buffered saline aqueous solution was prepared. Both solutions were mixed in 1:1 volume ratio (1 mL:1 mL), and 20 μL of photoinitiator was added in the ink solution. The tips of a one-dimensional array of nanoscopic tips (M-type probe, NanoInk, Inc.) were coated with the ink composition using an inkwell (DNA probe inkwell, NanoInk, Inc.) by dipping for 1 min. 10×10 dots arrays of the ink composition were deposited from the tips onto a hexemathyldisilazane spin-coated glass slide using 1 s dwell time at ambient condition. Next, the ink composition was exposed to UV light in order to convert the hydrogel precursor into a hydrogel. Photo-polymerization to hydrogel was carried out by exposing UV light (10 mW/cm², 365 nm) for 8 min with inert nitrogen gas atmosphere. The patterned hydrogel was examined using fluorescence microscopy. A schematic illustration of the deposition process is shown in FIG. 5A and the resulting fluorescence image is shown in FIG. 5B, confirming the encapsulation of the protein.

### Example 3

FIG. 6 illustrates how temperature can be used to control the size of the depositions, wherein a warmer temperature provided a larger deposition.

### Example 4

FIG. 7 illustrates additional patterning of hydrogel nanostructures.

### Examples 5 and 6

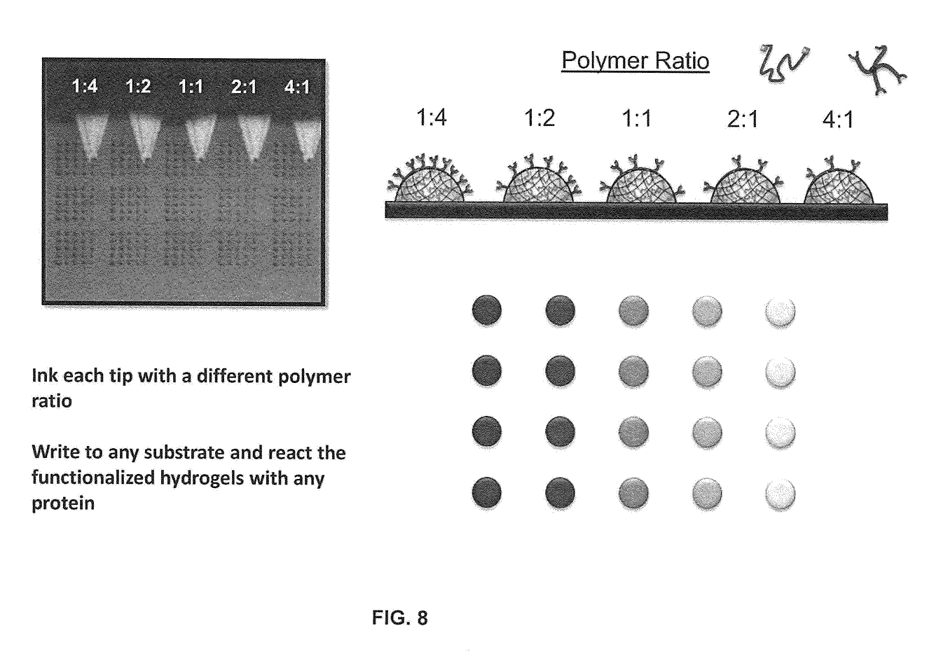

FIG. 8 (Example 5) and FIG. 9 (Example 6) illustrate different polymer ratios and gradient arrays.

### Example 7

### Ink Composition A and Patterning

An ink formulation A was prepared and patterned as follows:

### Materials:

i) Poly(ethylene glycol) dimethacrylate (PEG-DMA)
   From Polysciences, Inc, MW 1000 Da., catalog#15178-100, 100 g
ii) Poly(ethylene glycol) dimethacrylate (PEG-DMA)
   From Sigma-Aldrich, MW 2000 Da., catalog#409510, 250 mL
iii) 2,2-Diethoxyacetophenone, >95%, Sigma-Aldrich, catalog#227102, 500 g
iv) M-type cantilever pens (NanoInk, Inc.)

Substrate:
Hexamethyldisilazane (HMDS) spin-coated glass.
   a. A few drops of HMDS was placed on a cover glass with whole coverage;
   b. The glass was spin coated with 5000 rpm for 1 min;
   c. The coated glass was post baked by a hotplate 120° C. for 10 min.
Silicon dioxide substrate (NanoInk, Inc.)

Hydrogel precursor preparation:

1. 2:1 (w/w) ratio of solid PEG-DMA (MW 1000 Da) to liquid PEG-DMA (MW 500 Da) were put in a 200 mL vial and thoroughly mixed by sonicating until the solid part clearly melted into the liquid part;

2. The mixture was split into 20 μl aliquots and stored at 4° C.;

3. An aliquot was thawed at room temperature. A 1% volume of the photo-initiator (2,2-diethoxyacetophenone, 0.2 μl) was added in the PEG-DMA mixture just before printing;

4. A 0.2 μl of the solution was used to fill each reservoir of a NanoInk's M-type reservoir chip.

Pens:

1. An M type 1D array of 12 cantilever pens (NanoInk, Inc.) were used to pattern the hydrogel precursors. The pens were treated with oxygen plasma for 45 seconds prior to use.

Printing:

1. The M-type cantilever pens were loaded by dipping in the micro reservoir of the reservoir chip filled with hydrogel precursor.

2a. For printing less than 2 μm dot array, excessive hydrogel precursor on the pens was removed by bleeding 5 times on the blotting substrate before printing.

2b. The patterning was carried out at 25° C. and 20% RH with dwell time 1 sec. At this condition, each pen could consistently print 50 spots, with a spot size of about 1.5 microns. Steps 1 and 2 were then repeated in order to print more spots.

3a. For printing bigger than 5 μm dot array, automatic re-inking procedure after 5×5 dots array was set in the NLP2000 pattern design tool (NanoInk, Inc.).

3b. The pattering was carried out at 37° C. and 20% RH with dwell time 0.5 sec. The printing will carried out continuously by setting runs in the NLP pattern design tool. Printing spot size was about 5 microns.

Polymerization:

1. The patterned substrate was exposed to UV irradiation for 10 mins with N₂ gas purging to polymerize the precursors and form the hydrogels.

### Example 8

### Additional Ink Formulation B and Patterning

Materials:
v) Four-armed poly(ethylene glycol) thiol (4-Arm PEG-SH)
   From Creative PEGWorks, catalog# PSB-440, 1 g
   MW 2000 Da
vi) Poly(ethylene glycol) dimethacrylate (PEG-DMA)
   From Polysciences, Inc, catalog#15178-100, 100 g
   MW 1000 Da
vii) M-type cantilever pens

Substrate:

Acrylo Silane SuperChip™ substrate from Thermo Scientific was used as received.

Hydrogel precursor preparation:

1. 1:2 (w/w) ratio of PEG-DMA to 4-Arm PEG-SH were weighed in a 1 ml eppendorf tube and thoroughly mixed by sonicating for 5 mins.

2. The mixture was split into 20 μl aliquots and stored at −20° C.;

3. An aliquot was thawed at room temperature and 0.2 μl of the solution was used to fill each reservoir of a NanoInk's M-type reservoir chip.

Pens:

2. An M type 1D array of 12 cantilever pens (NanoInk, Inc.) were used to pattern the hydrogel precursors. The pens were treated with oxygen plasma for 45 seconds prior to use.

Printing:

1. The M-type cantilever pens were loaded by dipping in the micro reservoir of the reservoir chip filled with hydrogel precursor.

2. Excessive hydrogel precursor on the pens was removed by bleeding 5 times on the blotting substrate before printing.

3. The patterning was carried out at 25° C. and 35% RH with a dwell time of 0.2 sec. At this condition, each pen could consistently print 100 spots, with a spot size of 4 microns. Steps 1 and 2 were then repeated in order to print more spots.

Polymerization:

1. The patterned substrate was exposed to UV irradiation for 30 mins to polymerize the precursors and form the hydrogels.

### ADDITIONAL EMBODIMENTS: FIRST SET

The following 79 embodiments were described in priority application, U.S. Provisional Application Ser. No. 61/225,530 filed Jul. 14, 2009:

Embodiment 1. A method comprising: providing at least one nanoscopic tip, coating the tip with at least one ink composition, depositing the ink composition onto at least one substrate, wherein the ink composition comprises at least one hydrogel precursor, the hydrogel precursor adapted to form a hydrogel.

Embodiment 2. The method of Embodiment 1, wherein the nanoscopic tip comprises an AFM tip.

Embodiment 3. The method of Embodiment 1, wherein the nanoscopic tip comprises a solid tip.

Embodiment 4. The method of Embodiment 1, wherein the nanoscopic tip comprises a hollow tip.

Embodiment 5. The method of Embodiment 1, wherein the method comprises providing a plurality of nanoscopic tips.

Embodiment 6. The method of Embodiment 1, wherein the method comprises providing a one-dimensional array of nanoscopic tips.

Embodiment 7. The method of Embodiment 1, wherein the method comprises providing a two-dimensional array of nanoscopic tips.

Embodiment 8. The method of Embodiment 1, wherein the coating step comprises dipping the tip into the ink composition.

Embodiment 9. The method of Embodiment 1, wherein the coating step comprises providing an inkwell loaded with the ink composition.

Embodiment 10. The method of Embodiment 1, wherein the depositing step comprises positioning the tip in proximity to the substrate for a dwell time, wherein the dwell time is 0.1 s or more.

Embodiment 11. The method of Embodiment 1, wherein the depositing step comprises positioning the tip in proximity to the substrate for a dwell time, wherein the dwell time is 1 s or more.

Embodiment 12. The method of Embodiment 1, wherein the depositing step comprises positioning the tip in proximity to the substrate for a dwell time, wherein the dwell time is 5 s or more.

Embodiment 13. The method of Embodiment 1, wherein the depositing step is carried out at a humidity level sufficient to hydrate the hydrogel formed from the hydrogel precursor.

Embodiment 14. The method of Embodiment 1, wherein the depositing step is carried out at a humidity level sufficient to hydrate the hydrogel formed from the hydrogel precursor, wherein the humidity level is about 10% or more.

Embodiment 15. The method of Embodiment 1, wherein the hydrogel precursor is a solid at room temperature.

Embodiment 16. The method of Embodiment 1, wherein the hydrogel precursor comprises poly(ethylene glycol), poly(ethylene oxide), poly(acrylic acid), poly(methyacrylic acid), poly(2-hydroxyethyl methacrylate), poly(vinyl alcohol), poly(N-isopropylacrylamide), poly(lactic acid), poly(glycolic acid), agarose, chitosan or combinations thereof.

Embodiment 17. The method of Embodiment 1, wherein the hydrogel precursor comprises poly(ethylene glycol).

Embodiment 18. The method of Embodiment 1, wherein the hydrogel precursor comprises at least one crosslinkable group.

Embodiment 19. The method of Embodiment 1, wherein the hydrogel precursor comprises at least one crosslinkable group selected from an aldehyde, an amine, a hydrazide, a (meth)acrylate, or a thiol group.

Embodiment 20. The method of Embodiment 1, wherein the hydrogel precursor comprises at least one first functional group adapted to bind a target material.

Embodiment 21. The method of Embodiment 1, wherein the hydrogel precursor comprises at least one first functional group adapted to bind a target material, and further wherein the target material comprises a chemical molecule, biomolecule, cell, or biological organism.

Embodiment 22. The method of Embodiment 1, wherein the hydrogel precursor comprises at least one first functional group adapted to bind a target material, and further wherein the first functional group is selected from an amine, a carboxyl, a thiol, a maleimide, an epoxide, a (meth)acrylate, or a hydroxyl group.

Embodiment 23. The method of Embodiment 1, wherein the hydrogel precursor comprises at least one second functional group adapted to bind to the surface of the substrate.

Embodiment 24. The method of Embodiment 1, wherein the hydrogel precursor comprises at least one second functional group adapted to bind to the surface of the substrate, and further wherein the second functional group is selected from a thiol or a silane group.

Embodiment 25. The method of Embodiment 1, wherein the ink composition further comprises a solvent.

Embodiment 26. The method of Embodiment 1, wherein the ink composition further comprises a crosslinking agent.

Embodiment 27. The method of Embodiment 1, wherein the ink composition further comprises a crosslinking agent and the crosslinking agent is a free-radical initiator.

Embodiment 28. The method of Embodiment 1, wherein the ink composition further comprises a crosslinking agent and the crosslinking agent is a free-radical photoinitiator.

Embodiment 29. The method of Embodiment 1, wherein the ink composition further comprises at least one entity adapted to be encapsulated in the hydrogel formed from the hydrogel precursor.

Embodiment 30. The method of Embodiment 1, wherein the ink composition further comprises at least one entity adapted to be encapsulated in the hydrogel formed from the hydrogel precursor, and further wherein the entity comprises at least one third functional group adapted to bind to the surface of the substrate.

Embodiment 31. The method of Embodiment 1, wherein the ink composition further comprises at least one entity adapted to be encapsulated in the hydrogel formed from the hydrogel precursor, and further wherein the entity comprises at least one fourth functional group adapted to bind to a target material.

Embodiment 32. The method of Embodiment 1, wherein the ink composition further comprises at least one entity adapted to be encapsulated in the hydrogel formed from the hydrogel precursor, and further wherein the entity is a biomolecule.

Embodiment 33. The method of Embodiment 1, wherein the ink composition further comprises at least one entity adapted to be encapsulated in the hydrogel formed from the hydrogel precursor, and further wherein the entity comprises at least one third functional group adapted to bind to the surface of the substrate and the entity is a biomolecule.

Embodiment 34. The method of Embodiment 1, wherein the ink composition further comprises at least one entity adapted to be encapsulated in the hydrogel formed from the hydrogel precursor, and further wherein the entity is a polymer.

Embodiment 35. The method of Embodiment 1, wherein the ink composition further comprises at least one entity adapted to be encapsulated in the hydrogel formed from the hydrogel precursor, and further wherein the entity comprises at least one fourth functional group adapted to bind to a target material and the entity is a polymer.

Embodiment 36. The method of Embodiment 1, wherein the ink composition further comprises a crosslinking agent, a solvent, and at least one entity adapted to be encapsulated in the hydrogel formed from the hydrogel precursor.

Embodiment 37. The method of Embodiment 1, wherein the hydrogel precursor comprises poly(ethylene oxide) and the ink composition further comprises a free-radical initiator, a solvent, and at least one entity adapted to be encapsulated in the hydrogel formed from the hydrogel precursor, and further wherein the entity is a biomolecule.

Embodiment 38. The method of Embodiment 1, wherein the hydrogel precursor is poly(ethylene oxide) dimethacrylate and the ink composition further comprises a free-radical photoinitiator, a solvent, and at least one entity adapted to be encapsulated in the hydrogel formed from the hydrogel precursor, and further wherein the entity is a biomolecule.

Embodiment 39. The method of Embodiment 1, wherein the method further comprises converting the hydrogel precursor to the hydrogel.

Embodiment 40. The method of Embodiment 1, wherein the method further comprises converting the hydrogel precursor to the hydrogel without exposing the hydrogel precursor to an electron beam.

Embodiment 41. The method of Embodiment 1, wherein the method further comprises converting the hydrogel precursor to the hydrogel by exposing the hydrogel precursor to UV light.

Embodiment 42. The method of Embodiment 1, further comprising hydrating the ink composition.

Embodiment 43. The method of Embodiment 1, wherein the method further comprises converting the hydrogel precursor to the hydrogel and hydrating the hydrogel.

Embodiment 44. The method of Embodiment 1, further comprising modifying the substrate so that the ink composition deposited thereon forms an increased height upon deposition as compared to an unmodified substrate.

Embodiment 45. The method of Embodiment 1, wherein the depositing step provides a plurality of deposits of ink composition on the substrate.

Embodiment 46. The method of Embodiment 1, wherein the depositing step provides a pattern on the surface of the substrate, the pattern comprising isolated regions of deposited ink composition.

Embodiment 47. The method of Embodiment 1, wherein the depositing step provides an array on the surface of the substrate, the array comprising isolated regions of deposited ink composition.

Embodiment 48. The method of Embodiment 1, wherein the depositing step provides a pattern on the surface of the substrate, the pattern comprising isolated regions of deposited ink composition, and further wherein at least one of the isolated regions has a lateral dimension of 1000 nm or less.

Embodiment 49. The method of Embodiment 1, wherein the depositing step provides a pattern on the surface of the substrate, the pattern comprising isolated regions of deposited ink composition, and further wherein at least one of the isolated regions has a lateral dimension of 100 nm or less.

Embodiment 50. The method of Embodiment 1, wherein the depositing step provides a pattern on the surface of the substrate, the pattern comprising isolated regions of deposited ink composition, and further wherein the ink composition of at least one of the isolated regions is different from the ink composition of at least another of the isolated regions.

Embodiment 51. An article comprising: a substrate, and at least one deposit of ink composition on the substrate, wherein the ink composition comprises a hydrogel precursor adapted to form a hydrogel, and further wherein, the deposit has a lateral dimension of 100 μm or less.

Embodiment 52. The article of Embodiment 51, wherein the deposit has a lateral dimension of 1 μm or less.

Embodiment 53. The article of Embodiment 51, wherein the hydrogel precursor is not crosslinked.

Embodiment 54. The article of Embodiment 51, wherein the ink composition further comprises at least one entity adapted to be encapsulated in the hydrogel formed from the hydrogel precursor.

Embodiment 55. The article of Embodiment 51, wherein the ink composition further comprises at least one entity adapted to be encapsulated in, but not bound to, the hydrogel formed from the hydrogel precursor.

Embodiment 56. The article of Embodiment 51, wherein the ink composition further comprises at least one entity adapted to be encapsulated in the hydrogel formed from the hydrogel precursor, and further wherein the entity is a biomolecule or a polymer.

Embodiment 57. The article of Embodiment 51, wherein the article comprises a plurality of deposits of ink composition, the deposits arranged in a pattern and separated by regions on the substrate substantially free from ink composition.

Embodiment 58. The article of Embodiment 51, wherein the article comprises a plurality of deposits of ink composition, the deposits arranged in a pattern, and further wherein the ink composition of at least one deposit is different from the ink composition of at least another deposit.

Embodiment 59. An article comprising: a substrate, and a plurality of deposits of ink composition on the substrate, wherein the ink composition comprises a hydrogel precursor adapted to form a hydrogel, and further wherein the ink composition of at least one deposit is different from the ink composition of at least another deposit.

Embodiment 60. The article of Embodiment 59, further wherein the hydrogel precursor in the ink composition of at least one deposit is different from the hydrogel precursor in the ink composition of at least another deposit.

Embodiment 61. The article of Embodiment 59, wherein the ink composition further comprises at least one entity adapted to be encapsulated in the hydrogel formed from the hydrogel precursor.

Embodiment 62. The article of Embodiment 59, wherein the ink composition further comprises at least one entity adapted to be encapsulated in the hydrogel formed from the hydrogel precursor, and further wherein the entity is a biomolecule or a polymer.

Embodiment 63. The article of Embodiment 59, wherein the ink composition further comprises at least one entity adapted to be encapsulated in the hydrogel formed from the hydrogel precursor and the entity in the ink composition of at least one deposit is different from the entity in the ink composition of at least another deposit.

Embodiment 64. An ink composition comprising: at least one solvent, at least one hydrogel precursor, the hydrogel precursor adapted to form a hydrogel, wherein the ink composition is adapted for coating a nanoscopic tip and for depositing the ink composition from the nanoscopic tip to a substrate.

Embodiment 65. The ink composition of Embodiment 64, wherein the hydrogel precursor is a solid at room temperature.

Embodiment 66. The ink composition of Embodiment 64, wherein the hydrogel precursor comprises poly(ethylene glycol), poly(ethylene oxide), poly(acrylic acid), poly(methyacrylic acid), poly(2-hydroxyethyl methacrylate), poly(vinyl alcohol), poly(N-isopropylacrylamide), poly(lactic acid), poly(glycolic acid), agarose, chitosan, or combinations thereof.

Embodiment 67. The ink composition of Embodiment 64, wherein the hydrogel precursor comprises at least one crosslinkable group.

Embodiment 68. The ink composition of Embodiment 64, wherein the hydrogel precursor comprises at least one first functional group adapted to bind a target material.

Embodiment 69. The ink composition of Embodiment 64, wherein the hydrogel precursor comprises at least one second functional group adapted to bind to the surface of the substrate.

Embodiment 70. The ink composition of Embodiment 64, wherein the hydrogel precursor comprises at least one second functional group adapted to bind to the surface of the substrate, and further wherein the second functional group is selected from a thiol or a silane group.

Embodiment 71. The ink composition of Embodiment 64, wherein the ink composition further comprises a crosslinking agent.

Embodiment 72. The ink composition of Embodiment 64, wherein the ink composition further comprises at least one entity adapted to be encapsulated in the hydrogel formed from the hydrogel precursor.

Embodiment 73. The ink composition of Embodiment 64, wherein the ink composition further comprises at least one entity adapted to be encapsulated in the hydrogel formed from the hydrogel precursor, and further wherein the entity is a biomolecule.

Embodiment 74. The ink composition of Embodiment 64, wherein the ink composition further comprises at least one entity adapted to be encapsulated in the hydrogel formed from the hydrogel precursor, the entity is a biomolecule, and the biomolecule comprises at least one third functional group adapted to bind to the surface of the substrate.

Embodiment 75. The ink composition of Embodiment 64, wherein the ink composition further comprises at least one entity adapted to be encapsulated in the hydrogel formed from the hydrogel precursor, and further wherein the entity is a polymer.

Embodiment 76. The ink composition of Embodiment 64, wherein the ink composition further comprises at least one entity adapted to be encapsulated in the hydrogel formed from the hydrogel precursor, the entity is a polymer, and the polymer comprises at least one fourth functional group adapted to bind to a target material.

Embodiment 77. A method comprising: depositing a capture molecule from a nanoscopic tip to a substrate, depositing a hydrogel precursor from a nanoscopic tip to the deposited capture molecule, the hydrogel precursor adapted to form a hydrogel.

Embodiment 78. A method comprising: providing at least one stamp, coating the stamp with at least one ink composition, depositing the ink composition onto at least one substrate, wherein the ink composition comprises at least one hydrogel precursor, the hydrogel precursor adapted to form a hydrogel.

Embodiment 79. A method comprising: providing at least one tip optionally disposed on at least one cantilever, disposing on the tip at least one ink composition, optionally, drying the ink composition, depositing the optionally dried ink composition onto at least one substrate, wherein the ink composition comprises at least one hydrogel precursor, converting the hydrogel precursor to form a hydrogel.

### ADDITIONAL EMBODIMENTS: SECOND SET

In addition, the following 80 embodiments (1A-80A) were described in priority U.S. Provisional Application Ser. No. 61/314,498 filed Mar. 16, 2010.

Embodiment 1A. A method comprising: providing at least one nanoscopic tip, coating the tip with at least one ink composition, depositing the ink composition onto at least one substrate, wherein the ink composition comprises at least one hydrogel precursor, the hydrogel precursor adapted to form a hydrogel and ink comprises at least two different polymers as hydrogel precursor.

Embodiment 2A. The method of Embodiment 1A, wherein the nanoscopic tip comprises an AFM tip.

Embodiment 3A. The method of Embodiment 1A, wherein the nanoscopic tip comprises a solid tip.

Embodiment 4A. The method of Embodiment 1A, wherein the nanoscopic tip comprises a hollow tip.

Embodiment 5A. The method of Embodiment 1A, wherein the method comprises providing a plurality of nanoscopic tips.

Embodiment 6A. The method of Embodiment 1A, wherein the method comprises providing a one-dimensional array of nanoscopic tips.

Embodiment 7A. The method of Embodiment 1A, wherein the method comprises providing a two-dimensional array of nanoscopic tips.

Embodiment 8A. The method of Embodiment 1A, wherein the coating step comprises dipping the tip into the ink composition.

Embodiment 9A. The method of Embodiment 1A, wherein the coating step comprises providing an inkwell loaded with the ink composition.

Embodiment 10A. The method of Embodiment 1A, wherein the depositing step comprises positioning the tip in proximity to the substrate for a dwell time, wherein the dwell time is 0.1 s or more.

Embodiment 11A. The method of Embodiment 1A, wherein the depositing step comprises positioning the tip in proximity to the substrate for a dwell time, wherein the dwell time is 1 s or more.

Embodiment 12A. The method of Embodiment 1A, wherein the depositing step comprises positioning the tip in proximity to the substrate for a dwell time, wherein the dwell time is 5 s or more.

Embodiment 13A. The method of Embodiment 1A, wherein the depositing step is carried out at a humidity level sufficient to hydrate the hydrogel formed from the hydrogel precursor.

Embodiment 14A. The method of Embodiment 1A, wherein the depositing step is carried out at a humidity level sufficient to hydrate the hydrogel formed from the hydrogel precursor, wherein the humidity level is about 10% or more.

Embodiment 15A. The method of Embodiment 1A, wherein the hydrogel precursor is a solid at room temperature.

Embodiment 16A. The method of Embodiment 1A, wherein the hydrogel precursor comprises poly(ethylene glycol), poly(ethylene oxide), poly(acrylic acid), poly(methyacrylic acid), poly(2-hydroxyethyl methacrylate), poly(vinyl alcohol), poly(N-isopropylacrylamide), poly(lactic acid), poly(glycolic acid), agarose, chitosan or combinations thereof.

Embodiment 17A. The method of Embodiment 1A, wherein the hydrogel precursor comprises poly(ethylene glycol).

Embodiment 18A. The method of Embodiment 1A, wherein the hydrogel precursor comprises at least one crosslinkable group.

Embodiment 19A. The method of Embodiment 1A, wherein the hydrogel precursor comprises at least one crosslinkable group selected from an aldehyde, an amine, a hydrazide, a (meth)acrylate, or a thiol group.

Embodiment 20A. The method of Embodiment 1A, wherein the hydrogel precursor comprises at least one first functional group adapted to bind a target material.

Embodiment 21A. The method of Embodiment 1A, wherein the hydrogel precursor comprises at least one first functional group adapted to bind a target material, and further wherein the target material comprises a chemical molecule, biomolecule, cell, or biological organism.

Embodiment 22A. The method of Embodiment 1A, wherein the hydrogel precursor comprises at least one first functional group adapted to bind a target material, and further wherein the first functional group is selected from an amine, a carboxyl, a thiol, a maleimide, an epoxide, a (meth)acrylate, or a hydroxyl group.

Embodiment 23A. The method of Embodiment 1A, wherein the hydrogel precursor comprises at least one second functional group adapted to bind to the surface of the substrate.

Embodiment 24A. The method of Embodiment 1A, wherein the hydrogel precursor comprises at least one second functional group adapted to bind to the surface of the substrate, and further wherein the second functional group is selected from a thiol or a silane group.

Embodiment 25A. The method of Embodiment 1A, wherein the ink composition further comprises a solvent.

Embodiment 26A. The method of Embodiment 1A, wherein the ink composition further comprises a crosslinking agent.

Embodiment 27A. The method of Embodiment 1A, wherein the ink composition further comprises a crosslinking agent and the crosslinking agent is a free-radical initiator.

Embodiment 28A. The method of Embodiment 1A, wherein the ink composition further comprises a crosslinking agent and the crosslinking agent is a free-radical photoinitiator.

Embodiment 29A. The method of Embodiment 1A, wherein the ink composition further comprises at least one entity adapted to be encapsulated in the hydrogel formed from the hydrogel precursor.

Embodiment 30A. The method of Embodiment 1A, wherein the ink composition further comprises at least one entity adapted to be encapsulated in the hydrogel formed from the hydrogel precursor, and further wherein the entity comprises at least one third functional group adapted to bind to the surface of the substrate.

Embodiment 31A. The method of Embodiment 1A, wherein the ink composition further comprises at least one entity adapted to be encapsulated in the hydrogel formed from the hydrogel precursor, and further wherein the entity comprises at least one fourth functional group adapted to bind to a target material.

Embodiment 32A. The method of Embodiment 1A, wherein the ink composition further comprises at least one entity adapted to be encapsulated in the hydrogel formed from the hydrogel precursor, and further wherein the entity is a biomolecule.

Embodiment 33A. The method of Embodiment 1A, wherein the ink composition further comprises at least one entity adapted to be encapsulated in the hydrogel formed from the hydrogel precursor, and further wherein the entity comprises at least one third functional group adapted to bind to the surface of the substrate and the entity is a biomolecule.

Embodiment 34A. The method of Embodiment 1A, wherein the ink composition further comprises at least one entity adapted to be encapsulated in the hydrogel formed from the hydrogel precursor, and further wherein the entity is a polymer.

Embodiment 35A. The method of Embodiment 1A, wherein the ink composition further comprises at least one entity adapted to be encapsulated in the hydrogel formed from the hydrogel precursor, and further wherein the entity comprises at least one fourth functional group adapted to bind to a target material and the entity is a polymer.

Embodiment 36A. The method of Embodiment 1A, wherein the ink composition further comprises a crosslinking agent, a solvent, and at least one entity adapted to be encapsulated in the hydrogel formed from the hydrogel precursor.

Embodiment 37A. The method of Embodiment 1A, wherein the hydrogel precursor comprises poly(ethylene oxide) and the ink composition further comprises a free-radical initiator, a solvent, and at least one entity adapted to be encapsulated in the hydrogel formed from the hydrogel precursor, and further wherein the entity is a biomolecule.

Embodiment 38A. The method of Embodiment 1A, wherein the hydrogel precursor is poly(ethylene oxide) dimethacrylate and the ink composition further comprises a free-radical photoinitiator, a solvent, and at least one entity adapted to be encapsulated in the hydrogel formed from the hydrogel precursor, and further wherein the entity is a biomolecule.

Embodiment 39A. The method of Embodiment 1A, wherein the method further comprises converting the hydrogel precursor to the hydrogel.

Embodiment 40A. The method of Embodiment 1A, wherein the method further comprises converting the hydrogel precursor to the hydrogel without exposing the hydrogel precursor to an electron beam.

Embodiment 41A. The method of Embodiment 1A, wherein the method further comprises converting the hydrogel precursor to the hydrogel by exposing the hydrogel precursor to UV light.

Embodiment 42A. The method of Embodiment 1A, further comprising hydrating the ink composition.

Embodiment 43A. The method of Embodiment 1A, wherein the method further comprises converting the hydrogel precursor to the hydrogel and hydrating the hydrogel.

Embodiment 44A. The method of Embodiment 1A, further comprising modifying the substrate so that the ink composition deposited thereon forms an increased height upon deposition as compared to an unmodified substrate.

Embodiment 45A. The method of Embodiment 1A, wherein the depositing step provides a plurality of deposits of ink composition on the substrate.

Embodiment 46A. The method of Embodiment 1A, wherein the depositing step provides a pattern on the surface of the substrate, the pattern comprising isolated regions of deposited ink composition.

Embodiment 47A. The method of Embodiment 1A, wherein the depositing step provides an array on the surface of the substrate, the array comprising isolated regions of deposited ink composition.

Embodiment 48A. The method of Embodiment 1A, wherein the depositing step provides a pattern on the surface of the substrate, the pattern comprising isolated regions of deposited ink composition, and further wherein at least one of the isolated regions has a lateral dimension of 1000 nm or less.

Embodiment 49A. The method of Embodiment 1A, wherein the depositing step provides a pattern on the surface of the substrate, the pattern comprising isolated regions of deposited ink composition, and further wherein at least one of the isolated regions has a lateral dimension of 100 nm or less.

Embodiment 50A. The method of Embodiment 1A, wherein the depositing step provides a pattern on the surface of the substrate, the pattern comprising isolated regions of deposited ink composition, and further wherein the ink composition of at least one of the isolated regions is different from the ink composition of at least another of the isolated regions.

Embodiment 51A. An article comprising: a substrate, and at least one deposit of ink composition on the substrate, wherein the ink composition comprises a hydrogel precursor adapted to form a hydrogel, and further wherein, the deposit has a lateral dimension of 100 μm or less, wherein the ink composition comprises at least two different polymers.

Embodiment 52A. The article of Embodiment 51A, wherein the deposit has a lateral dimension of 1 μm or less.

Embodiment 53A. The article of Embodiment 51A, wherein the hydrogel precursor is not crosslinked.

Embodiment 54A. The article of Embodiment 51A, wherein the ink composition further comprises at least one entity adapted to be encapsulated in the hydrogel formed from the hydrogel precursor.

Embodiment 55A. The article of Embodiment 51A, wherein the ink composition further comprises at least one entity adapted to be encapsulated in, but not bound to, the hydrogel formed from the hydrogel precursor.

Embodiment 56A. The article of Embodiment 51A, wherein the ink composition further comprises at least one entity adapted to be encapsulated in the hydrogel formed from the hydrogel precursor, and further wherein the entity is a biomolecule or a polymer.

Embodiment 57A. The article of Embodiment 51A, wherein the article comprises a plurality of deposits of ink composition, the deposits arranged in a pattern and separated by regions on the substrate substantially free from ink composition.

Embodiment 58A. The article of Embodiment 51A, wherein the article comprises a plurality of deposits of ink composition, the deposits arranged in a pattern, and further wherein the ink composition of at least one deposit is different from the ink composition of at least another deposit.

Embodiment Embodiment 59A. An article comprising: a substrate, and a plurality of deposits of ink composition on the substrate, wherein the ink composition comprises a hydrogel precursor adapted to form a hydrogel, wherein the ink comprises at least two different polymers, and further wherein the ink composition of at least one deposit is different from the ink composition of at least another deposit.

Embodiment 60A. The article of Embodiment 59A, further wherein the hydrogel precursor in the ink composition of at least one deposit is different from the hydrogel precursor in the ink composition of at least another deposit.

Embodiment 61A. The article of Embodiment 59A, wherein the ink composition further comprises at least one entity adapted to be encapsulated in the hydrogel formed from the hydrogel precursor.

Embodiment 62A. The article of Embodiment 59A, wherein the ink composition further comprises at least one entity adapted to be encapsulated in the hydrogel formed from the hydrogel precursor, and further wherein the entity is a biomolecule or a polymer.

Embodiment 63A. The article of Embodiment 59A, wherein the ink composition further comprises at least one entity adapted to be encapsulated in the hydrogel formed from the hydrogel precursor and the entity in the ink composition of at least one deposit is different from the entity in the ink composition of at least another deposit.

Embodiment 64A. An ink composition comprising: at least one solvent, at least one hydrogel precursor, the hydrogel precursor adapted to form a hydrogel, wherein the precursor comprises at least two different polymers, wherein the ink composition is adapted for coating a nanoscopic tip and for depositing the ink composition from the nanoscopic tip to a substrate.

Embodiment 65A. The ink composition of Embodiment 64A, wherein the hydrogel precursor is a solid at room temperature.

Embodiment 66A. The ink composition of Embodiment 64A, wherein the hydrogel precursor comprises poly(ethylene glycol), poly(ethylene oxide), poly(acrylic acid), poly(methyacrylic acid), poly(2-hydroxyethyl methacrylate), poly(vinyl alcohol), poly(N-isopropylacrylamide), poly(lactic acid), poly(glycolic acid), agarose, chitosan, or combinations thereof.

Embodiment 67A. The ink composition of Embodiment 64A, wherein the hydrogel precursor comprises at least one crosslinkable group.

Embodiment 68A. The ink composition of Embodiment 64A, wherein the hydrogel precursor comprises at least one first functional group adapted to bind a target material.

Embodiment 69A. The ink composition of Embodiment 64A, wherein the hydrogel precursor comprises at least one second functional group adapted to bind to the surface of the substrate.

Embodiment 70A. The ink composition of Embodiment 64A, wherein the hydrogel precursor comprises at least one second functional group adapted to bind to the surface of the substrate, and further wherein the second functional group is selected from a thiol or a silane group.

Embodiment 71A. The ink composition of Embodiment 64A, wherein the ink composition further comprises a crosslinking agent.

Embodiment 72A. The ink composition of Embodiment 64A, wherein the ink composition further comprises at least one entity adapted to be encapsulated in the hydrogel formed from the hydrogel precursor.

Embodiment 73A. The ink composition of Embodiment 64A, wherein the ink composition further comprises at least one entity adapted to be encapsulated in the hydrogel formed from the hydrogel precursor, and further wherein the entity is a biomolecule.

Embodiment 74A. The ink composition of Embodiment 64A, wherein the ink composition further comprises at least one entity adapted to be encapsulated in the hydrogel formed from the hydrogel precursor, the entity is a biomolecule, and the biomolecule comprises at least one third functional group adapted to bind to the surface of the substrate.

Embodiment 75A. The ink composition of Embodiment 64A, wherein the ink composition further comprises at least one entity adapted to be encapsulated in the hydrogel formed from the hydrogel precursor, and further wherein the entity is a polymer.

Embodiment 76A. The ink composition of Embodiment 64A, wherein the ink composition further comprises at least one entity adapted to be encapsulated in the hydrogel formed from the hydrogel precursor, the entity is a polymer, and the polymer comprises at least one fourth functional group adapted to bind to a target material.

Embodiment 77A. A method comprising: depositing a capture molecule from a nanoscopic tip to a substrate, depositing a hydrogel precursor from a nanoscopic tip to the deposited capture molecule, the hydrogel precursor adapted to form a hydrogel and comprising at least two different polymers.

Embodiment 78A. A method comprising: providing at least one stamp, coating the stamp with at least one ink composition, depositing the ink composition onto at least one substrate, wherein the ink composition comprises at least one hydrogel precursor, the hydrogel precursor adapted to form a hydrogel and comprising at least two different polymers.

Embodiment 79A. A method comprising: providing at least one tip optionally disposed on at least one cantilever, disposing on the tip at least one ink composition, optionally, drying the ink composition, depositing the optionally dried ink composition onto at least one substrate, wherein the ink composition comprises at least one hydrogel precursor, wherein the precursor comprises at least two different polymers converting the hydrogel precursor to form a hydrogel.

Embodiment 80A. A method comprising: providing at least one nanoscopic tip, coating the tip with at least one ink composition, depositing the ink composition onto at least one substrate, wherein the ink composition comprises at least one hydrogel precursor, the hydrogel precursor adapted to form a hydrogel and ink comprises at least two different polymers as hydrogel precursor, wherein the first polymer is a linear polymer and the second polymer is a polymer comprising at least two arms.

What is claimed is:

1. A method comprising:
providing at least one nanoscopic tip,
coating the tip with at least one ink composition,
depositing the ink composition onto at least one substrate, wherein the ink composition comprises at least one hydrogel precursor, the hydrogel precursor adapted to form a hydrogel.

2. The method of claim 1, wherein the nanoscopic tip comprises an AFM tip.

3. The method of claim 1, wherein the nanoscopic tip comprises a solid tip.

4. The method of claim 1, wherein the depositing step is carried out at a humidity level sufficient to hydrate the hydrogel formed from the hydrogel precursor.

5. The method of claim 1, wherein the hydrogel precursor is a solid at room temperature.

6. The method of claim 1, wherein the hydrogel precursor comprises poly(ethylene glycol), poly(ethylene oxide), poly(acrylic acid), poly(methyacrylic acid), poly(2-hydroxyethyl methacrylate), poly(vinyl alcohol), poly(N-isopropylacrylamide), poly(lactic acid), poly(glycolic acid), agarose, chitosan or combinations thereof.

7. The method of claim 1, wherein the hydrogel precursor comprises poly(ethylene glycol).

8. The method of claim 1, wherein the hydrogel precursor comprises at least one crosslinkable group.

9. The method of claim 1, wherein the hydrogel precursor comprises at least one crosslinkable group selected from an aldehyde, an amine, a hydrazide, a (meth)acrylate, or a thiol group.

10. The method of claim 1, wherein the hydrogel precursor comprises at least one first functional group adapted to bind a target material.

11. The method of claim 1, wherein the hydrogel precursor comprises at least one first functional group adapted to bind a target material, and further wherein the target material comprises a chemical molecule, biomolecule, cell, or biological organism.

12. The method of claim 1, wherein the hydrogel precursor comprises at least one first functional group adapted to bind a target material, and further wherein the first functional group is selected from an amine, a carboxyl, a thiol, a maleimide, an epoxide, a (meth)acrylate, or a hydroxyl group.

13. The method of claim 1, wherein the hydrogel precursor comprises at least one second functional group adapted to bind to the surface of the substrate.

14. The method of claim 1, wherein the hydrogel precursor comprises at least one second functional group adapted to bind to the surface of the substrate, and further wherein the second functional group is selected from a thiol or a silane group.

15. The method of claim 1, wherein the ink composition further comprises a solvent.

16. The method of claim 1, wherein the ink composition further comprises a crosslinking agent.

17. The method of claim 1, wherein the ink composition further comprises a crosslinking agent and the crosslinking agent is a free-radical initiator.

18. The method of claim 1, wherein the ink composition further comprises a crosslinking agent and the crosslinking agent is a free-radical photoinitiator.

19. The method of claim 1, wherein the ink composition further comprises at least one entity adapted to be encapsulated in the hydrogel formed from the hydrogel precursor.

20. The method of claim 1, wherein the ink composition further comprises at least one entity adapted to be encapsulated in the hydrogel formed from the hydrogel precursor, and further wherein the entity comprises at least one third functional group adapted to bind to the surface of the substrate.

21. The method of claim 1, wherein the ink composition further comprises at least one entity adapted to be encapsulated in the hydrogel formed from the hydrogel precursor, and further wherein the entity comprises at least one fourth functional group adapted to bind to a target material.

22. The method of claim 1, wherein the ink composition further comprises at least one entity adapted to be encapsulated in the hydrogel formed from the hydrogel precursor, and further wherein the entity is a biomolecule.

23. The method of claim 1, wherein the ink composition further comprises at least one entity adapted to be encapsulated in the hydrogel formed from the hydrogel precursor, and further wherein the entity comprises at least one third functional group adapted to bind to the surface of the substrate and the entity is a biomolecule.

24. The method of claim 1, wherein the ink composition further comprises at least one entity adapted to be encapsulated in the hydrogel formed from the hydrogel precursor, and further wherein the entity is a polymer.

25. The method of claim 1, wherein the ink composition further comprises at least one entity adapted to be encapsulated in the hydrogel formed from the hydrogel precursor, and further wherein the entity comprises at least one fourth functional group adapted to bind to a target material and the entity is a polymer.

26. The method of claim 1, wherein the ink composition further comprises a crosslinking agent, a solvent, and at least one entity adapted to be encapsulated in the hydrogel formed from the hydrogel precursor.

27. The method of claim 1, wherein the hydrogel precursor comprises poly(ethylene oxide) and the ink composition further comprises a free-radical initiator, a solvent, and at least one entity adapted to be encapsulated in the hydrogel formed from the hydrogel precursor, and further wherein the entity is a biomolecule.

28. The method of claim 1, wherein the hydrogel precursor is poly(ethylene oxide) dimethacrylate and the ink composition further comprises a free-radical photoinitiator, a solvent, and at least one entity adapted to be encapsulated in the hydrogel formed from the hydrogel precursor, and further wherein the entity is a biomolecule.

29. The method of claim 1, wherein the method further comprises converting the hydrogel precursor to the hydrogel.

30. The method of claim 1, wherein the method further comprises converting the hydrogel precursor to the hydrogel without exposing the hydrogel precursor to an electron beam.

31. The method of claim 1, wherein the method further comprises converting the hydrogel precursor to the hydrogel by exposing the hydrogel precursor to UV light.

32. The method of claim 1, further comprising hydrating the ink composition.

33. The method of claim 1, wherein the method further comprises converting the hydrogel precursor to the hydrogel and hydrating the hydrogel.

34. The method of claim 1, further comprising modifying the substrate so that the ink composition deposited thereon forms an increased height upon deposition as compared to an unmodified substrate.

35. The method of claim 1, wherein the depositing step provides a plurality of deposits of the ink composition on the substrate.

36. The method of claim 1, wherein the depositing step provides a pattern on the surface of the substrate, the pattern comprising isolated regions of deposited ink composition.

37. The method of claim 1, wherein the depositing step provides an array on the surface of the substrate, the array comprising isolated regions of deposited ink composition.

38. The method of claim 1, wherein the depositing step provides a pattern on the surface of the substrate, the pattern comprising isolated regions of deposited ink composition, and further wherein at least one of the isolated regions has a lateral dimension of 1000 nm or less.

39. The method of claim 1, wherein the depositing step provides a pattern on the surface of the substrate, the pattern comprising isolated regions of deposited ink composition, and further wherein at least one of the isolated regions has a lateral dimension of 100 nm or less.

40. The method of claim 1, wherein the depositing step provides a pattern on the surface of the substrate, the pattern comprising isolated regions of deposited ink composition, and further wherein the ink composition of at least one of the isolated regions is different from the ink composition of at least another of the isolated regions.

41. An article comprising:
a substrate, and
at least one deposit of ink composition on the substrate,
wherein the ink composition comprises a hydrogel precursor adapted to form a hydrogel, and further wherein, the deposit has a lateral dimension of 100 μm or less.

42. The article of claim 41, wherein the deposit has a lateral dimension of 1 μm or less.

43. The article of claim 41, wherein the hydrogel precursor is not crosslinked.

44. The article of claim 41, wherein the ink composition further comprises at least one entity adapted to be encapsulated in the hydrogel formed from the hydrogel precursor.

45. The article of claim 41, wherein the ink composition further comprises at least one entity adapted to be encapsulated in, but not bound to, the hydrogel formed from the hydrogel precursor.

46. The article of claim 41, wherein the ink composition further comprises at least one entity adapted to be encapsulated in the hydrogel formed from the hydrogel precursor, and further wherein the entity is a biomolecule or a polymer.

47. An article comprising:
a substrate, and
a plurality of deposits of ink composition on the substrate, wherein the ink composition comprises a hydrogel precursor adapted to form a hydrogel, and further wherein the ink composition of at least one deposit is different from the ink composition of at least another deposit.

48. The article of claim 47, further wherein the hydrogel precursor in the ink composition of at least one deposit is different from the hydrogel precursor in the ink composition of at least another deposit.

49. The article of claim 47, wherein the ink composition further comprises at least one entity adapted to be encapsulated in the hydrogel formed from the hydrogel precursor.

50. The article of claim 47, wherein the ink composition further comprises at least one entity adapted to be encapsulated in the hydrogel formed from the hydrogel precursor, and further wherein the entity is a biomolecule or a polymer.

51. An ink composition comprising:
at least one solvent,
at least one hydrogel precursor, the hydrogel precursor adapted to form a hydrogel, wherein the ink composition is adapted for coating a nanoscopic tip and for depositing the ink composition from the nanoscopic tip to a substrate.

52. The ink composition of claim 51, wherein the hydrogel precursor comprises poly(ethylene glycol), poly(ethylene oxide), poly(acrylic acid), poly(methyacrylic acid), poly(2-hydroxyethyl methacrylate), poly(vinyl alcohol), poly(N-isopropylacrylamide), poly(lactic acid), poly(glycolic acid), agarose, chitosan, or combinations thereof.

53. The ink composition of claim 51, wherein the hydrogel precursor comprises at least one crosslinkable group.

54. The ink composition of claim 51, wherein the hydrogel precursor comprises at least one first functional group adapted to bind a target material.

55. The ink composition of claim 51, wherein the hydrogel precursor comprises at least one second functional group adapted to bind to the surface of the substrate.

56. The ink composition of claim 51, wherein the hydrogel precursor comprises at least one second functional group adapted to bind to the surface of the substrate, and further wherein the second functional group is selected from a thiol or a silane group.

57. The ink composition of claim 51, wherein the ink composition further comprises a crosslinking agent.

58. A method comprising:
depositing a capture molecule from a nanoscopic tip to a substrate,
depositing a hydrogel precursor from a nanoscopic tip to the deposited capture molecule, the hydrogel precursor adapted to form a hydrogel.

59. A method comprising:
providing at least one stamp,
coating the stamp with at least one ink composition,
depositing the ink composition onto at least one substrate, wherein the ink composition comprises at least one hydrogel precursor, the hydrogel precursor adapted to form a hydrogel.

60. A method comprising:
providing at least one tip optionally disposed on at least one cantilever,
disposing on the tip at least one ink composition,
optionally, drying the ink composition,
depositing the optionally dried ink composition onto at least one substrate, wherein the ink composition comprises at least one hydrogel precursor,
converting the hydrogel precursor to form a hydrogel.

61. A method comprising:
providing at least one nanoscopic tip,
coating the tip with at least one ink composition,
depositing the ink composition onto at least one substrate, wherein the ink composition comprises at least one hydrogel precursor, the hydrogel precursor adapted to form a hydrogel and ink comprises at least two different polymers as hydrogel precursor.

62. An article comprising:
a substrate, and
at least one deposit of ink composition on the substrate,
wherein the ink composition comprises a hydrogel precursor adapted to form a hydrogel, and further wherein, the deposit has a lateral dimension of 100 μm or less, wherein the ink composition comprises at least two different polymers.

63. An article comprising:
a substrate, and
a plurality of deposits of ink composition on the substrate, wherein the ink composition comprises a hydrogel precursor adapted to form a hydrogel, wherein the ink comprises at least two different polymers, and further wherein the ink composition of at least one deposit is different from the ink composition of at least another deposit.

64. An ink composition comprising:
at least one solvent,
at least one hydrogel precursor, the hydrogel precursor adapted to form a hydrogel, wherein the precursor comprises at least two different polymers, wherein the ink composition is adapted for coating a nanoscopic tip and for depositing the ink composition from the nanoscopic tip to a substrate.
